(19) United States
(12) Patent Application Publication
(10) Pub. No.: US 2012/0110027 A1
(43) Pub. Date: May 3, 2012

(54) Audience measurement system

(76) Inventor: Fernando Falcon, Lugano (CH)

(21) Appl. No.: 12/998,501

(22) PCT Filed: Oct. 28, 2008
(86) PCT No.: PCT/IB2008/002871

§ 371 Date: Oct. 17, 2011

(51) Int. Cl. G06F 7/00; H04N 21/24

(52) U.S. Cl. 707/802; 707/E17.044

(57) ABSTRACT

A computer implemented method is provided for generating audience information for a population. The method includes the steps of recording reference media consumption information for a plurality of reference panel elements, recording mass media consumption information for a plurality of mass panel elements and determining a correspondence between portions for reference panel of the reference and mass media consumption information obtained. Said correspondence is used to link at least one of the reference panel elements to at least one of the mass panel elements in order to define a session including media consumption information recorded for the linked reference and mass panel elements and to define audience information for the population therefrom.

The present invention regards a method for generating audience information by combining information from multiple sources.

### BACKGROUND

Knowing the size and demographic composition of audiences to media broadcasts is of paramount importance for the media industry.

According to certain known methods and practices, audience measurement is performed by means of a panel, which is a statistical sample comprising a set of respondents who agree to be monitored in terms of their exposure behaviour and media consumption choices on a continuous cyclic basis (the most common survey cycle being 24 hours) for a relatively long time period (usually spanning several survey cycles, e.g. 2 years). Respondents are usually recruited in groups for reasons of efficiency and operational convenience. For example, a standard practice in measuring television audiences is to recruit families or other social units living in the same dwelling (hereinafter “respondent families”, or “families” for short).

Monitoring exposure behaviour of each respondent may be performed in two basic modes: 1) monitoring respondents individually through some suitable method (hereinafter “individual metering”); or, 2) monitoring respondents indirectly by metering media devices used by them (hereinafter “device metering”). In all cases monitoring is usually performed according to predefined timeslots of each survey cycle (e.g. quarter hours or minutes of a day).

Individual metering may be performed by various known methods, for example providing diaries to be filled up by all respondents detailing their media consumption habits during each survey period, or by providing personal electronic metering systems that are worn by respondents during the whole active period (usually all hours of the day while they are awake).

Device metering is usually performed by installing metering apparatus to monitor all media rendering devices available for the group of respondents living in the same dwelling. Such metering systems are usually capable of registering status of rendering devices (e.g. activity, source of content, etc.) as well as identifying and registering the media consumption choices made by consumers (e.g. channels tuned at each given time slot of the survey).

Electronic metering apparatuses have traditionally existed only for measuring television audiences, mostly in the form of a set top device placed above all monitored TV sets in each recruited home. In most cases, consumers declare their exposure status by pressing a respective identification button on a specific remote control. Such an arrangement, known as “peoplemeter”, has become a standard for television audience measurement because it has traditionally been capable of providing audience data of acceptable quality at sustainable costs.

In conventional audience measurement methods, every family member (as well as each family as a whole) is assumed to reflect the habits of a segment of a population—that is, a relatively large number of consumers existing in the measured population having similar media consumption habits. A weight is thus estimated and assigned to each family and each family member according to standard statistical practices, and is used to expand the audience information obtained from the metering devices to reflect real audience figures referring to the whole population.

Traditional audience measurement methods using conventional respondent panels have always dealt with consumers having few options in terms of media consumption, which in turn keeps the required number of respondents at feasible levels.

However, the evolution of digital media distribution technologies has resulted in traditional panel sizes no longer being adequate to generate accurate audience figures for each one of the myriad options offered to an average media consumer in terms of media sources and consumption modes.

As media offerings continue to evolve into ever more granular choices, the probability of detecting exposure to any individual choice through a respondent panel decreases accordingly, which makes it more difficult to obtain meaningful and stable audience figures. One particularly significant example of this phenomenon is offered by “on demand” media distribution platforms, users of which can choose to watch television or listen to radio programs not only from a large number of channels, but also from a large number of discrete media items spanning past episodes of television programs, music videos, songs, films, etc., thus significantly enhancing the number of media consumption options offered to consumers.

Moreover, a generalized trend about declining cooperation rates from respondents in panels around the world has been consistently observed, which tends to increase the costs associated with panel maintenance (i.e. cost associated to quality control tasks and actions to persuade respondents to stay cooperative).

Several approaches have been proposed to tackle the problem posed by audience fragmentation in the media industry, by making use of anonymous screen panels. One known solution utilises “return path data” or “RPD”, as promoted by companies such as TNS and ADcom.

RPD solutions record “click stream” information comprising detailed logs of commands executed by media devices as they are operated. In an RPD scheme, each media device acts as a metering device that provides information only about consumption choices and modes (e.g. channel tuned and time shift), and usually for only one media source (e.g. the particular distribution platform for which the media device is used).

Although demographic information about potential consumers may be available through subscriber records, no demographic audience information can be reported because the actual identity and number of individuals operating the media device remains unknown; hence it is not possible to derive the habits of a corresponding population segment from this information alone. Predictive analytics are hence used to forecast the times at which particular consumer types are likely to be available for media consumption, and consumer data is subsequently synthesized through modelling algorithms. The synthesis process usually relies on a plurality of regression coefficients that need to be calibrated in order to make the synthetic data correlate the real behavioural data collected from a calibration panel as closely as possible. This requires collecting historical data to assess the probability that a potential consumer profile is in fact exposed to content produced by such media device in the measured population (sometimes called “PIV”, “probability of individuals viewing”).

Another important limitation of the RPD approach is that most media devices do not have rendering means of their own, but rely on a separate display that is usually shared with other media devices. For example, a DVD player and a set top box may be both connected to the same television set. In measurement of television audiences, set top boxes are often used as decoders, some of which have RPD capabilities. Even though a set top box may be enabled to record tuning information, it does not know whether the television set to which it is connected is actually turned on, or if it is switched to some other input such as a DVD player. To equate “tuning time” with “viewing time” in such a measurement system can therefore lead to extreme inaccuracies between the figures produced by the system as compared to actual viewing figures. Additional predictive analytics have been proposed to forecast the times at which a television set is likely to be turned off, or tuned to a DVD player and so on. This requires further calibration of coefficients against historical data.

Since all audience data produced by an RPD audience system is directly dependent on the accuracy with which its coefficients have been calibrated, the required collection period is typically not less than a few weeks in order to obtain usable coefficients. This rules out the possibility of reflecting particular events that may significantly affect the behaviour of media consumers, such as weather, breaking news, particular political circumstances, or, more extremely, unexpected events like those of 11 Sep. 2001, which increased by a large factor the probability of media consumption in the population as compared to any average day. For all these reasons, audience information obtained from systems that rely on such predictive analytics are not generally accepted as a reliable source of information for trading advertising space (i.e. cannot be used as a source of “currency” data).

In addition to the disadvantages discussed above, set top boxes are usually connected only to one of a plurality of TV sets that are in use in any given home, therefore RPD panels can produce only partial audience figures related to one media source, whilst all other means for consuming the same type of media by the population are not accounted for.

An alternative anonymous panel approach to tackle the problem of fragmenting television audiences has been proposed by Kirkham in 1993, as well as by Ephron and Baniel in 1999, and again by Ephron and Gray in 2000. This approach uses “set meters” which are still anonymous devices, but capable of understanding when a rendering device is turned on and active. However, although the set meter approach addresses the problem of determining if media items are actually rendered on a screen and (in some cases) determining the source of those media items, it still relies on analytic modelling to predict the presence and identity of consumers in media consumption sessions.

Other examples of anonymous panels are found in measurement of Internet audiences, where server logs provide detailed information about media consumption but no information about the consumers.

Anonymous panels have the potential advantage of producing sizeable cost savings because they are less expensive to operate than respondent panels (in the cases of RPD or Internet server logs by a very significant factor), and therefore are deemed a compromise solution to tackle the problem of fragmented media audiences. This advantage is enhanced by the global trend of declining response for respondent panels.

Nonetheless, known audience measurement methods based on anonymous panels still rely heavily on the art of predicting the demographic composition of audiences through mathematical models, imposing serious limitations in terms of quality and reliability of the output data, which are not necessarily compensated by the possibility of building larger panel sizes.

Moreover, any modelled solution relying on regression coefficients could potentially be easily tampered by unscrupulous individuals having access to data production facilities, since even slight variations in those coefficients can have a significant impact in the output data (e.g. the reported share of a particular television channel).

Other problems the media industry is facing in terms of audience measurement is the multiplicity of media consumption modes offered nowadays to an average consumer, many of which cannot be monitored by a set-top box meter (for example: iPod, portable DVD players, portable LCDs TV Sets, etc.).

Relatively recent developments in the field of individual metering technologies provide a partial solution to these problems. A personal meter is usually a device that can be worn by a user and is equipped with a microphone capable of capturing the ambient sound to which the user is being exposed, so that it can potentially identify the audio track of a radio or television program through an appropriate content identification technology. An example of a personal meter is the “Portable People Meter” or “PPM” currently offered by Arbitron Inc. in the United States and other countries. Each panel member must wear his/her device during most of the time they are awake, so that any content they might be exposed to can be captured by their respective devices. Personal audience meters are perceived as an appealing audience measurement solution because of the fact that they do not require installation and are therefore capable, in principle, of capturing all exposure situations, including those that cannot be measured through more conventional solutions. Personal audience meters have been also implemented using mobile phones running appropriate content identification software.

However, much has been debated about the inability of such metering technology to provide audience estimates of acceptable quality. Several drawbacks regarding personal devices have been evidenced during the last few years as a result of personal devices being tested in different situations. One example is given by the tests conducted on various personal meters by the Radio Joint Audience Research (RAJAR) in the United Kingdom during 2004, and more recently as well.

Among the deficiencies affecting such metering systems, one of the most apparent is that personal meters are burdensome for panel members, since they have to wear their respective devices during all the time they are awake (i.e. from dawn till they go to sleep at night). This excessive burden on users inevitably tends to reduce cooperation rates (and therefore audience levels), which has a significant impact on data quality.

Another important drawback of personal meters is that, in order to determine exposure to content being rendered by media devices (i.e. exposure status), personal meters must rely on proximity to the sound source. This implies a change in the definition of “measured media consumption”, since it overrides the direct concept of voluntary user declaration, replacing it with an indirect method based on recognition of certain specific content by an electronic device. It has not been proved that such a metering technique accurately reflects when a panel member is in a viewing situation, since it depends on a number of variables, only some of which are related to spatial proximity. For example, the physical posture of the person at any given time may be critical to the device's capability of recognizing the content being shown on a television device, since it could alter the acoustic path between the device's speaker and the meter's microphone, sometimes attenuating the sound level arriving at the personal meter, thereby turning the content identification process erratic or impossible.

Moreover, the recognition effectiveness of a personal meter can be influenced by several possible disturbances which may be affected by environmental variables, potentially modifying the overall audience values. For example, an acoustic phenomenon like reverberation can significantly alter a personal meter's performance (in terms of content identification), since it tends to scramble the original signal with unwanted copies of it, carrying various delays with respect to each other. Since reverberation levels are heavily dependent on weather conditions (e.g. temperature, pressure, humidity, etc.), all of these variables can potentially alter the average audience levels obtained by these devices.

Given the above-mentioned deficiencies, personal audience meters are unable to provide accurate exposure information on a continuous basis; reporting tends to be disrupted by technical limitations or cooperation issues. For all these reasons, personal audience meters are usually not considered appropriate replacements of more conventional techniques. Instead, they tend to be seen as a compromise solution when measuring various types of media exposure (e.g. radio and television) is required.

In summary, measuring audiences to media broadcasts is becoming ever more complex and costly due to relentless changes in distribution technologies. Conventional systems and methods are not coping with the new problems posed by such changes; therefore new concepts are required to tackle these problems in a cost effective way, yet minimizing any compromise on data quality.

The invention is set out in the claims. Because both reference, and mass panels reflect media consumption information concurrently for the same population, media consumption events detected in one panel can be linked to affine or corresponding events detected in the other panel, allowing the use of two or more metering systems for monitoring diverse aspects of similar media consumption phenomena. The method allows optimizing the use of available survey assets both in terms of cost and quality, and does not rely on predictive analytics or historical information, nor does it require calibration of regression coefficients. Instead, media consumption information detected on two or more active panels are combined through logic mechanisms to produce objective audience data from actual observed behaviour.

The method of the invention uses audience information obtained from one panel to supplement or enrich audience information obtained from another panel, enhancing the audience information obtainable therefrom. The method allows using low-cost metering technologies and techniques in larger “mass” panels providing low-level information in the form of a relatively limited set of media consumption information while more costly metering techniques are restricted to smaller “reference” panels providing high-level information in the form of a relatively enhanced set of media consumption information, optimizing allocation of survey assets; while still producing quality audience data comparable to that obtainable from more costly conventional techniques.

Moreover, traditional audience measuring methods and systems produce audience figures separately for each type of media, which means that any solution based on predicting media consumption variables regarding one particular platform or consumption mode (e.g. watching television at home) cannot provide information about other platforms or other consumption modes (e.g. watching television through Internet websites), and so they cannot provide a comprehensive picture about the media consumption habits of consumers as they interact with more than one type of media. This interaction is becoming of increasing interest and importance as the media environment becomes ever more complex. The approach according to the present invention accommodates this complexity.

Embodiments of the invention will now be described, by way of example, with reference to the drawings of which:

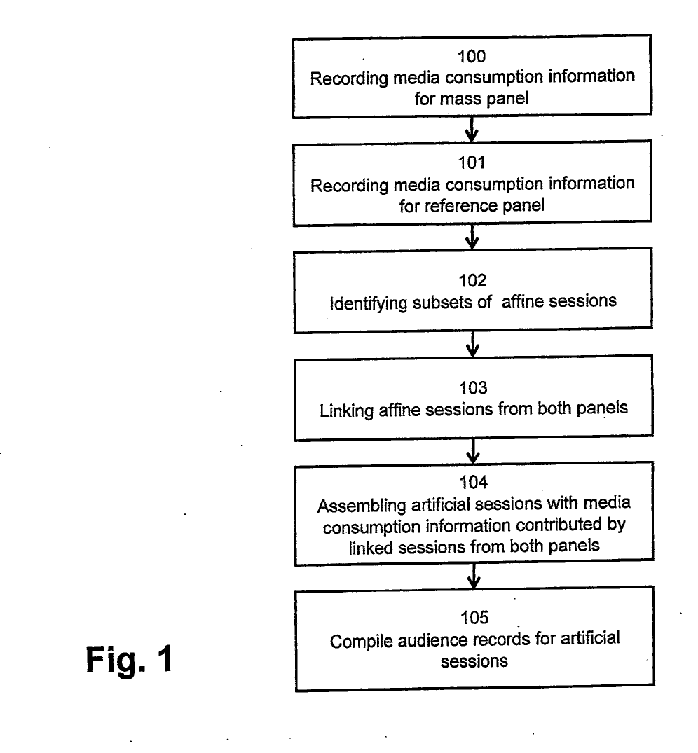

FIG. 1 is a flow diagram showing the steps performed according to the method described herein;

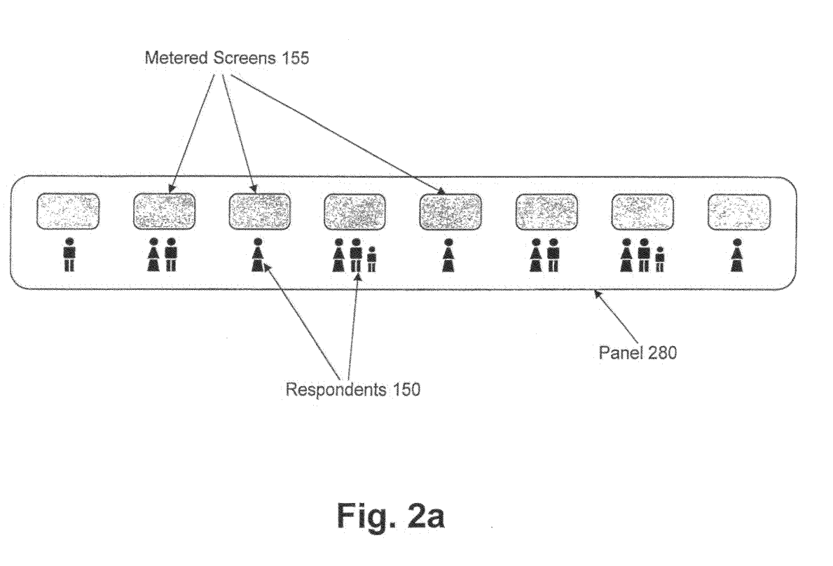

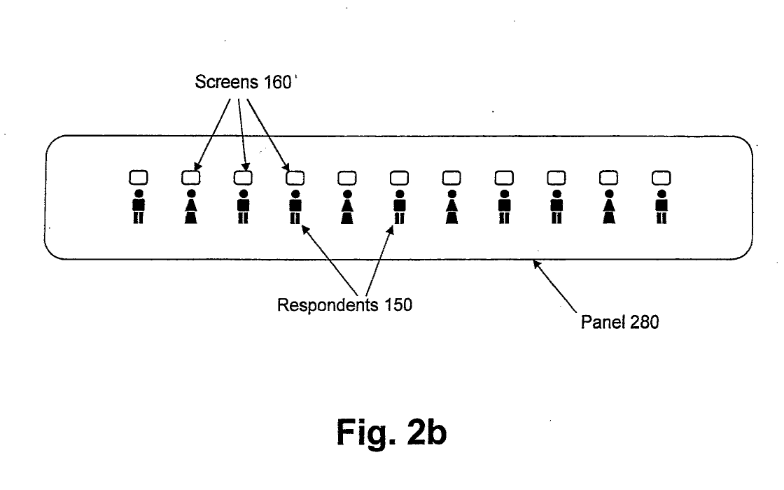

FIG. 2A shows schematically an audience measurement panel comprising metered media devices;

FIG. 2B shows schematically an audience measurement panel comprising personal metering systems;

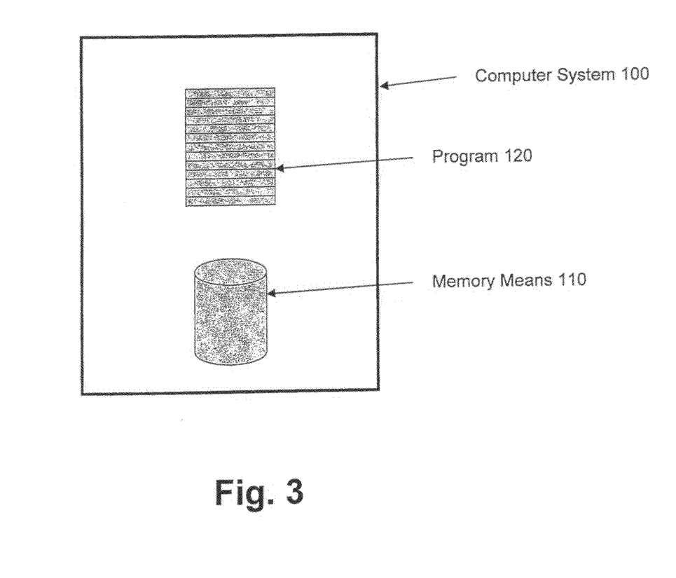

FIG. 3 shows the basic components of a computer system supporting the method described herein;

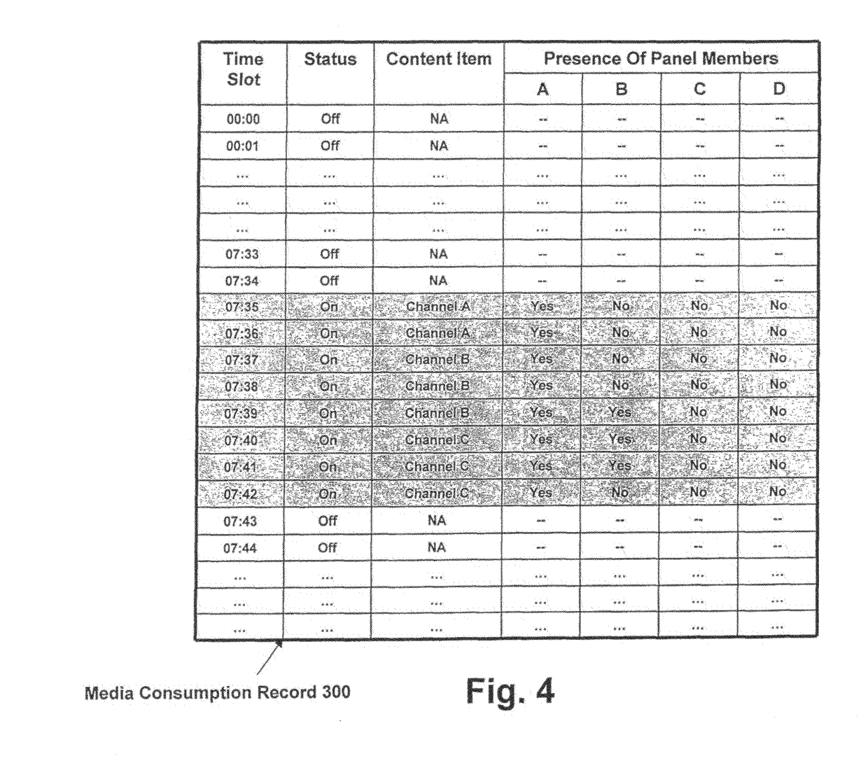

FIG. 4 shows an exemplary media consumption record;

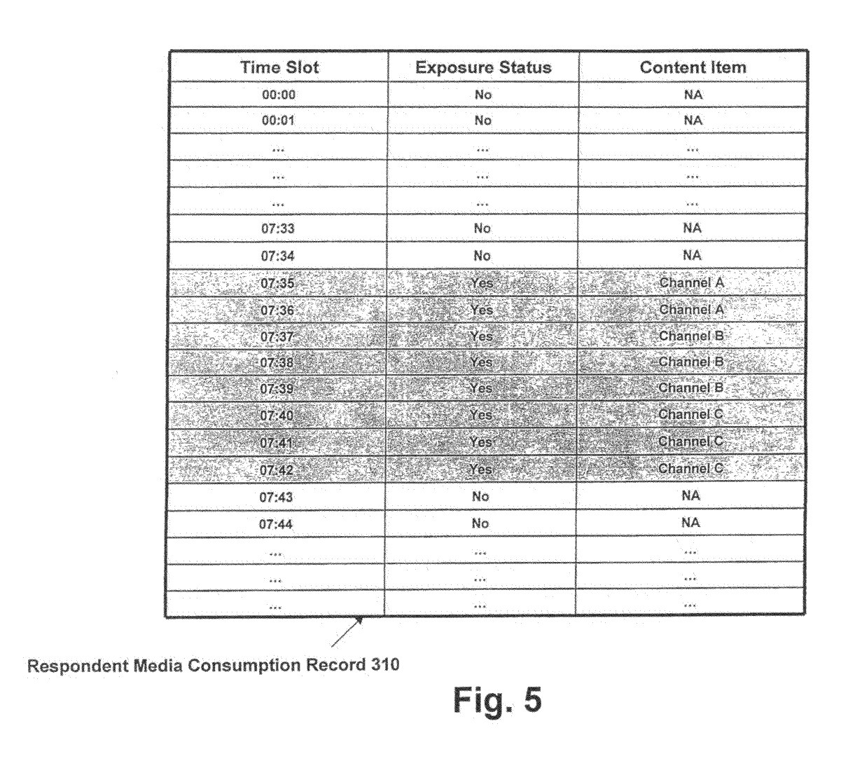

FIG. 5 shows an exemplary respondent media consumption record;

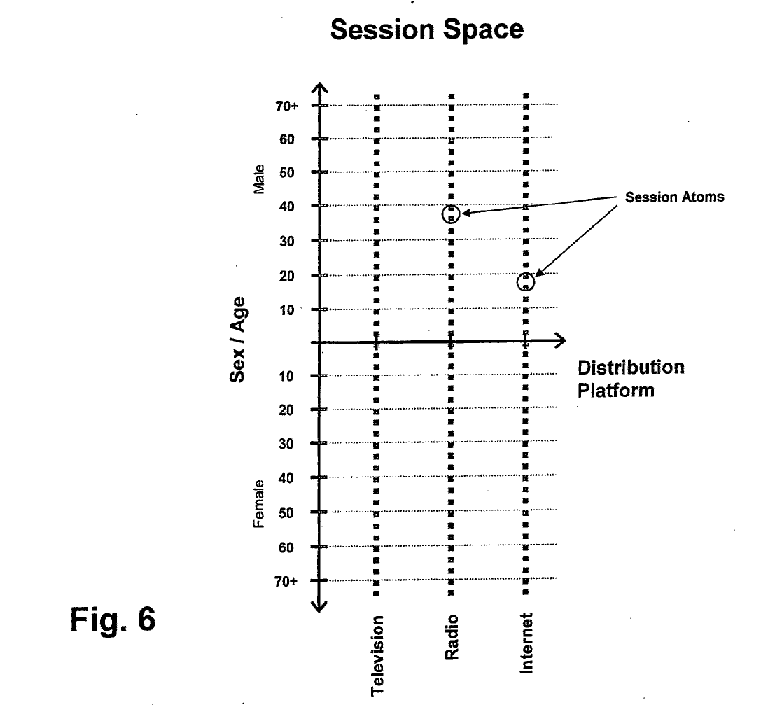

FIG. 6 shows an exemplary session space;

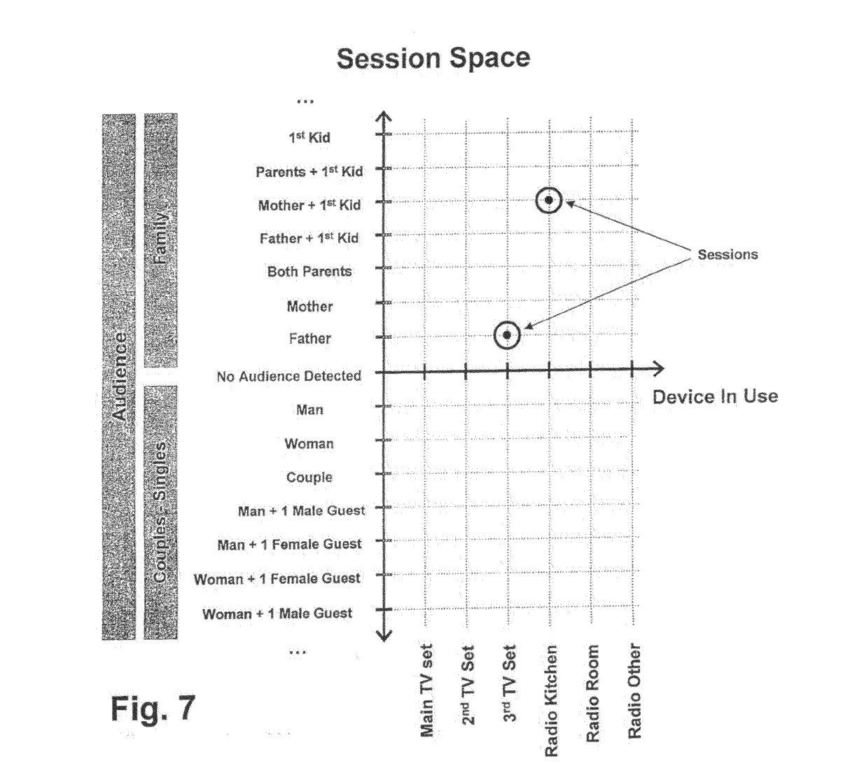

FIG. 7 shows an alternative exemplary session space;

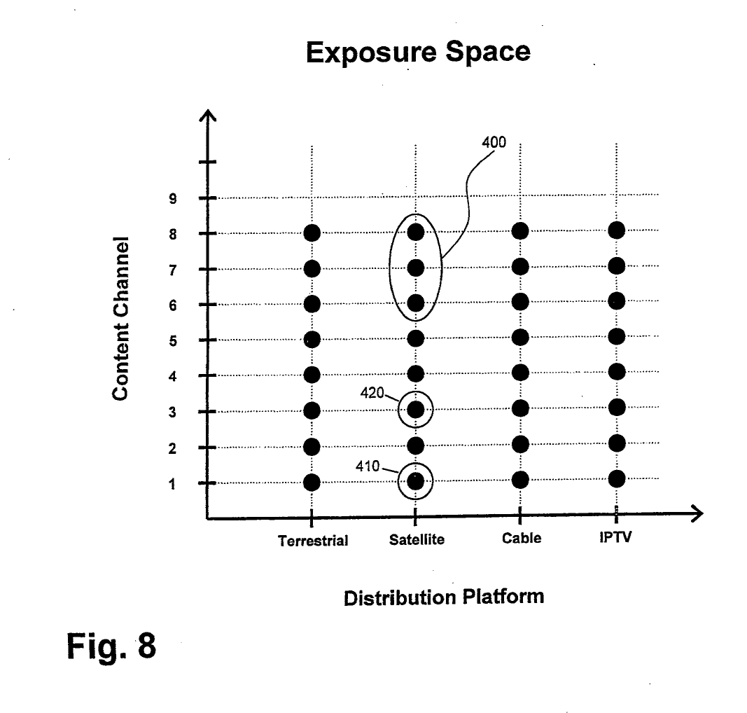

FIG. 8 shows an exemplary exposure space;

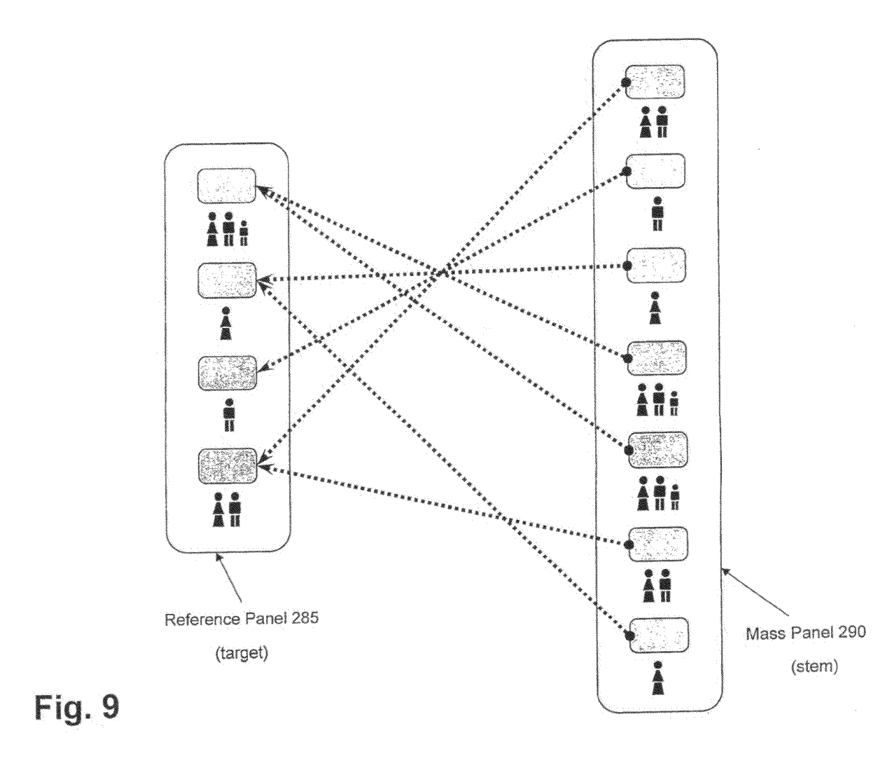

FIG. 9 shows schematically links created between a mass and reference panel;

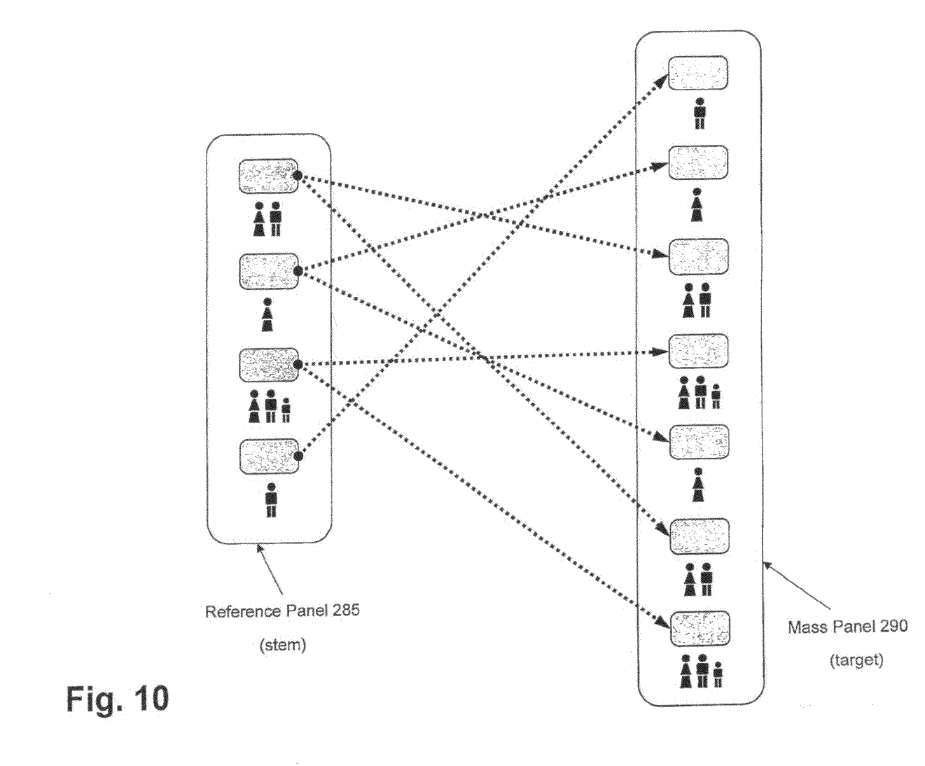

FIG. 10 shows schematically links created between a reference panel and mass panel;

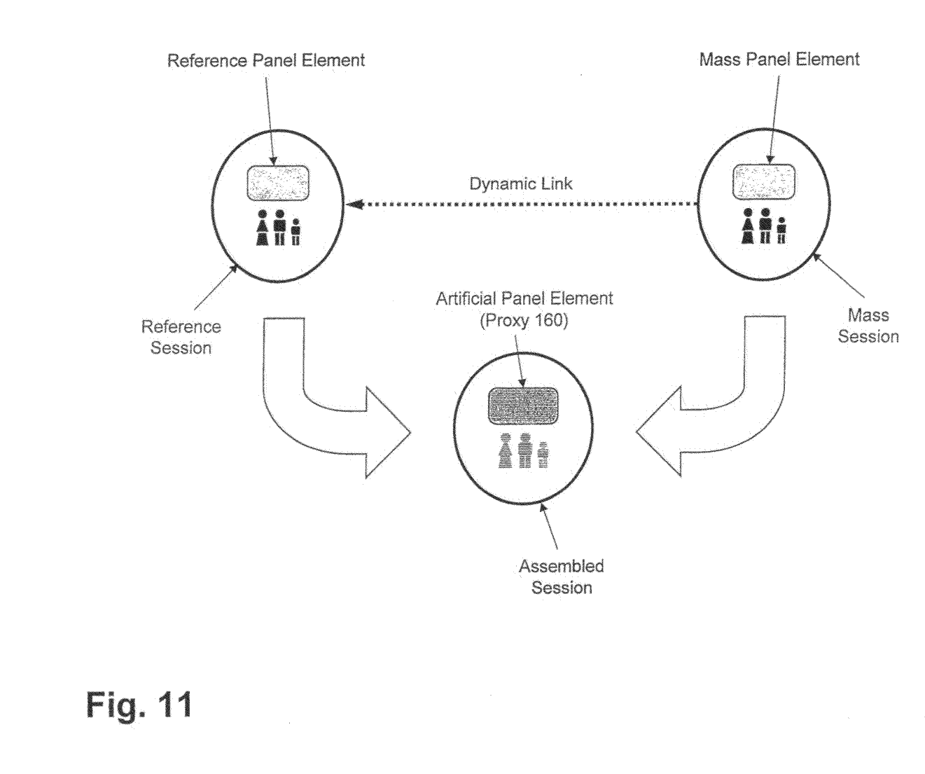

FIG. 11 shows links between a reference panel and mass panel element using an artificial panel element;

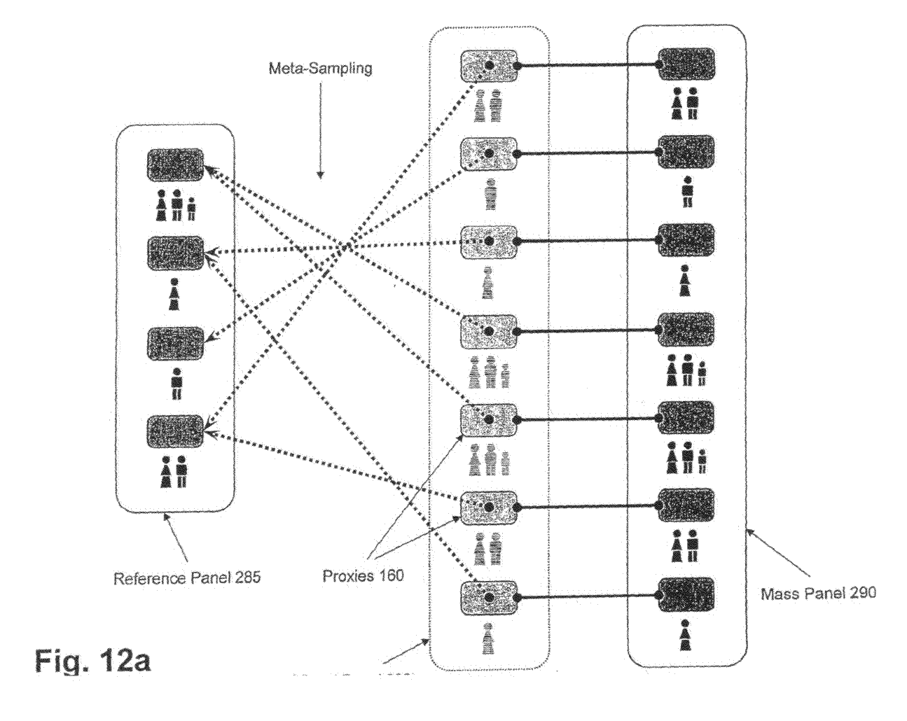

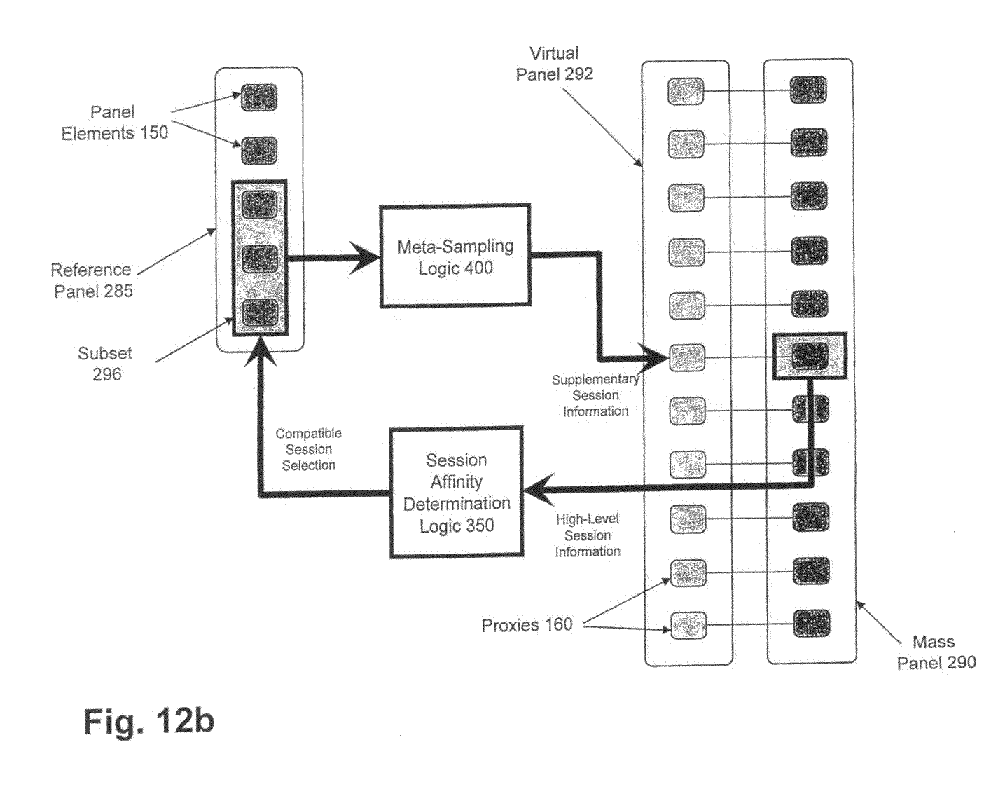

FIG. 12A shows creation of a proxy for each mass panel element;

FIG. 12B shows schematically assignment of mass and reference panel elements;

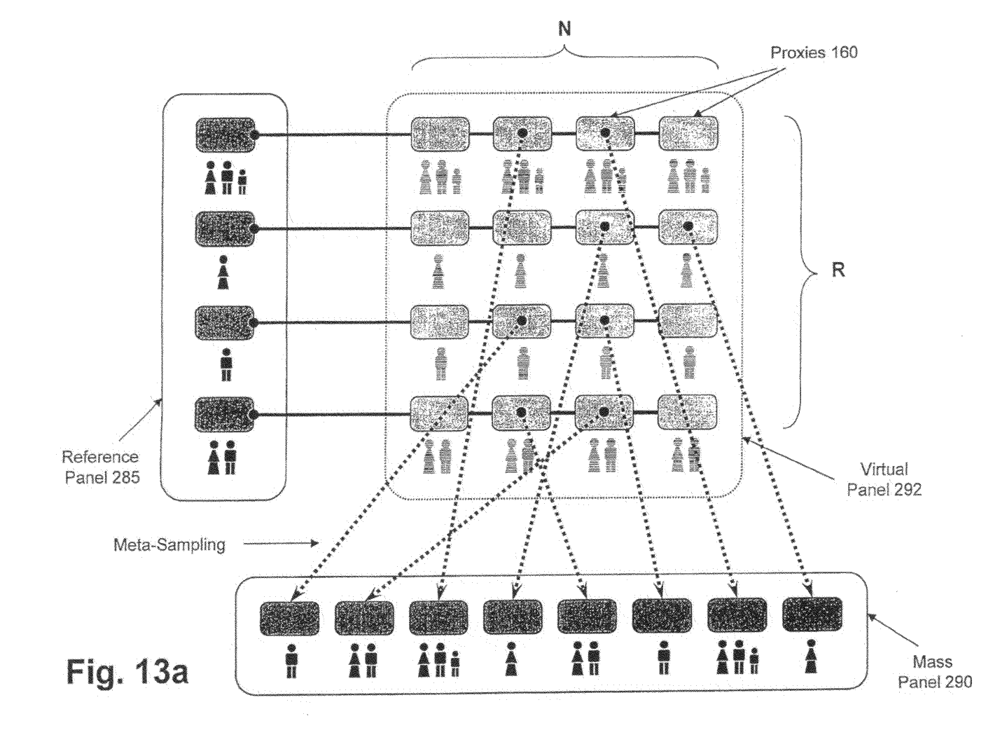

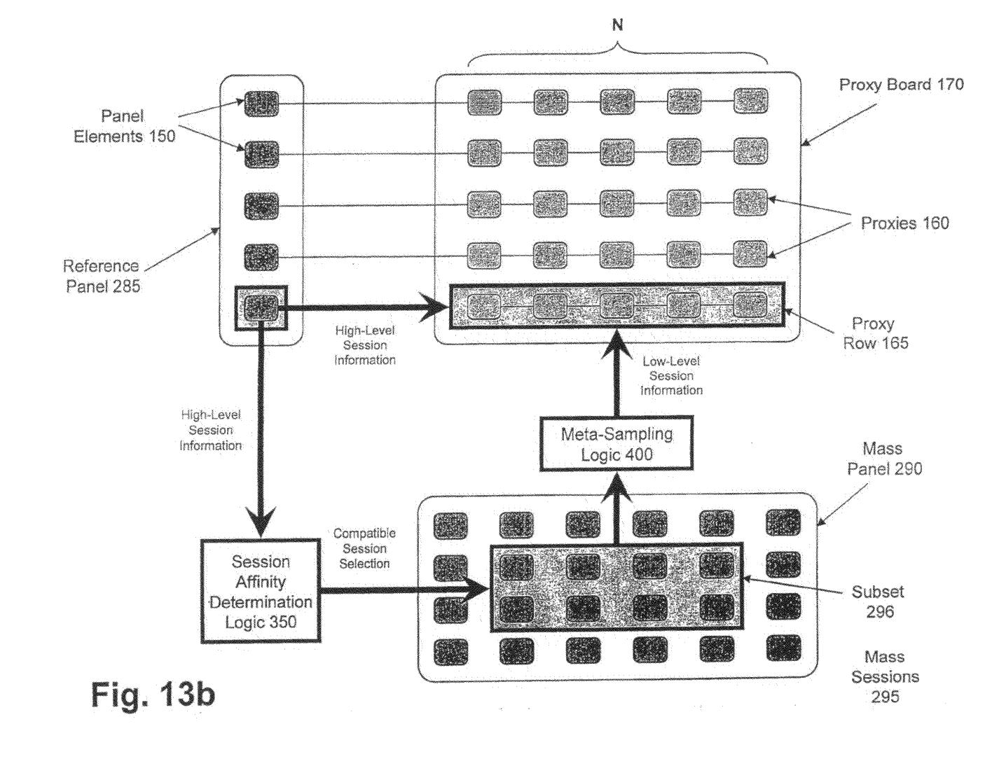

FIG. 13A shows use of a proxy board;

FIG. 13B shows use of a proxy board in block diagram fashion;

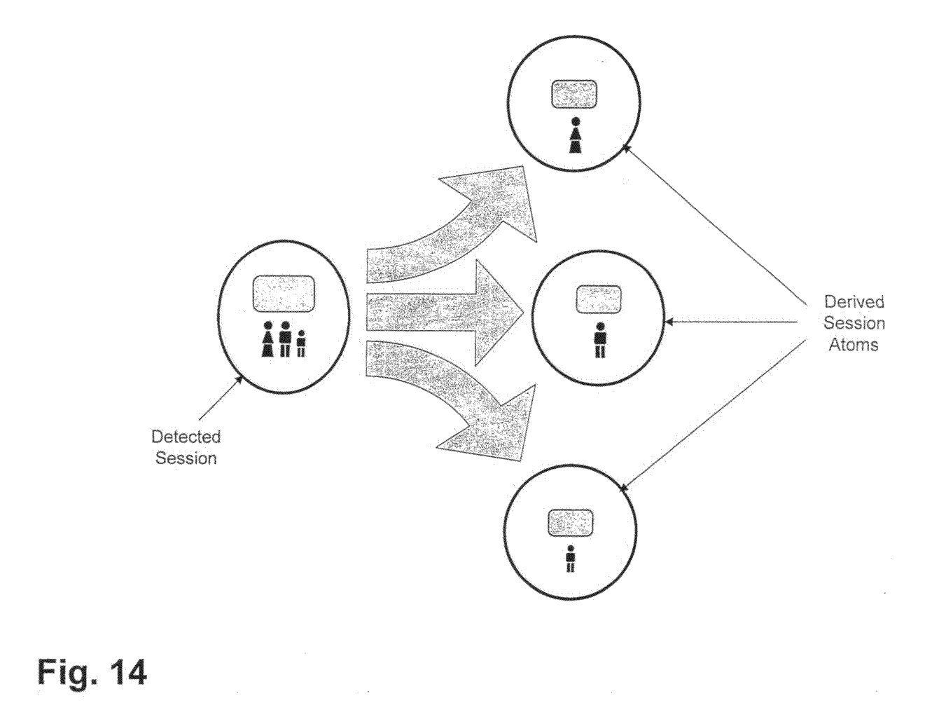

FIG. 14 shows schematically decomposition of a media consumption event;

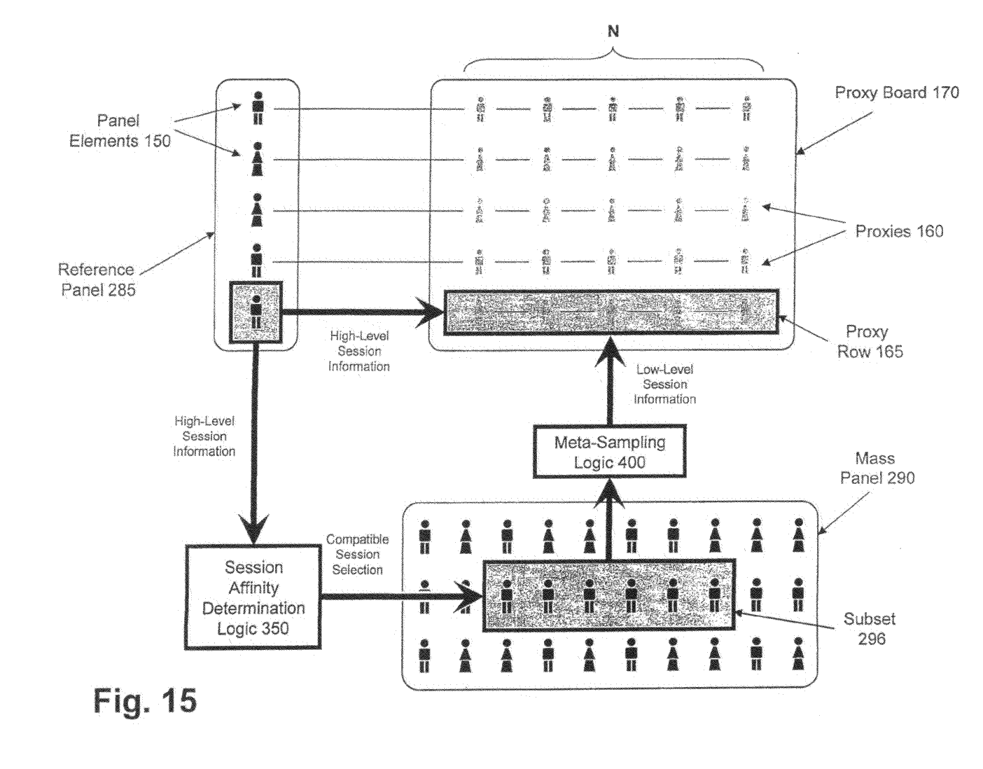

FIG. 15 shows linking of panel information using a proxy board;

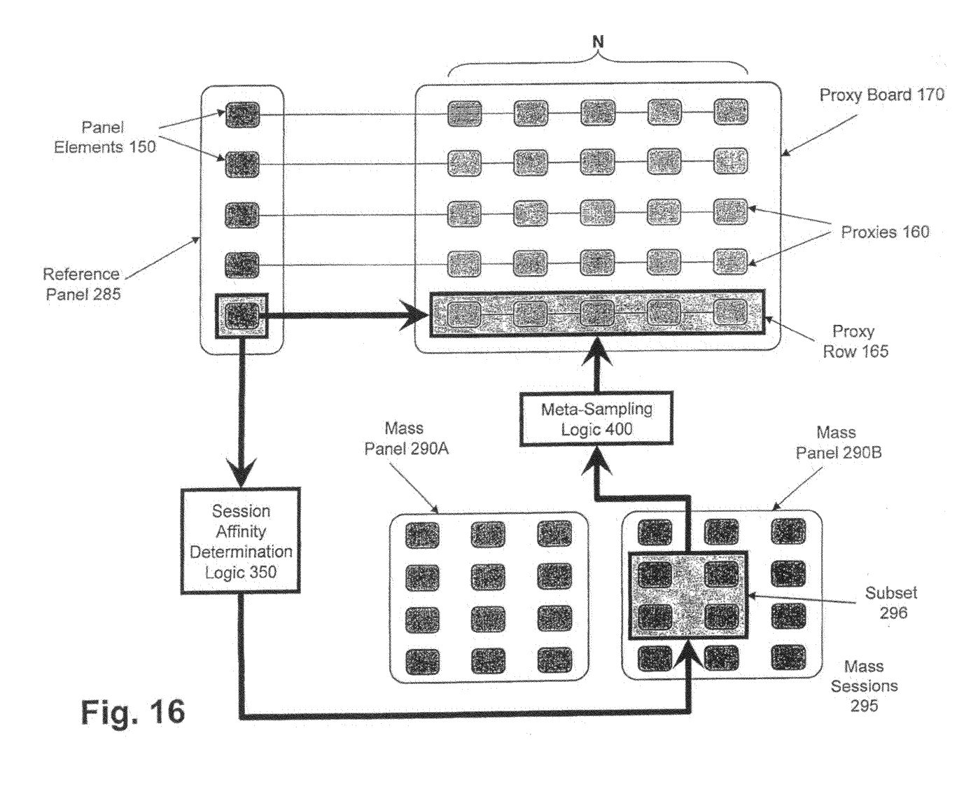

FIG. 16 shows linking of specific media consumption variables using a proxy board;

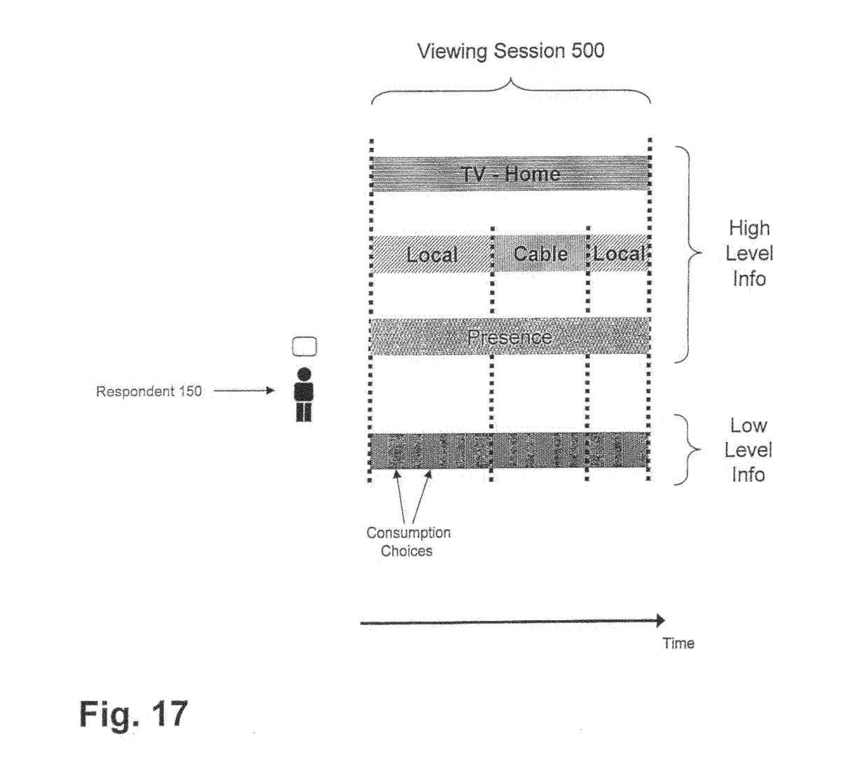

FIG. 17 depicts a respondent viewing session; and

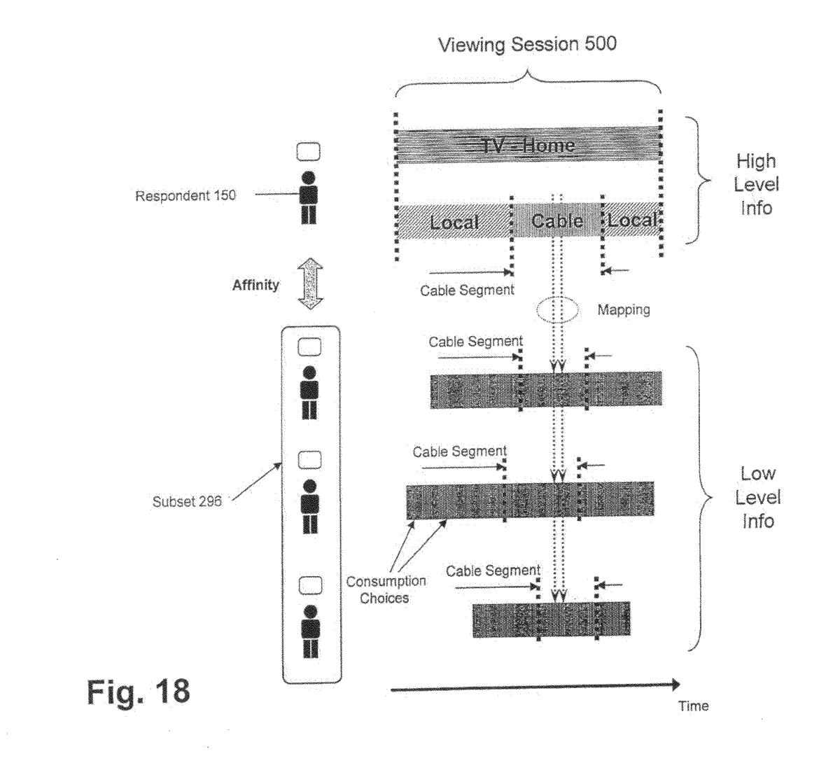

FIG. 18 shows an alternative respondent viewing session.

In overview, a method is provided of obtaining audience information for a population by combining media consumption data obtained from two concurrent panels; one of them being relatively small and using sophisticated metering equipment and practices (i.e. “reference panel”), while the other one being relatively large and using low cost metering equipment and practices (“mass panel”). The method includes recording media consumption information for the mass panel and the reference panel at steps 100 and 101, respectively (FIG. 1). Media consumption sessions detected in both panels that show an indication of correspondence or “affinity” are identified and classified in subsets at step 102 (according to predefined affinity criteria). For example, this may be a temporal correspondence meaning that the media consumption information was recorded at the same or a similar point in time or is temporally linked but time shifted. At step 103, statistical information units contributed by both panels are cross-mapped by linking affine sessions from both panels through a substantially random process (“meta-sampling”). Derived artificial sessions are then assembled at step 104 blending media consumption information elements contributed by linked sessions. At step 105, audience records are compiled from the artificial sessions assembled in step 104, which are collectively used as audience data for the whole population.

The method of the invention does not rely on predictive analytics nor does it require calibration of regression coefficients; it takes advantage of computational techniques to produce audience data through a logic mechanism that blends media consumption information contributed by one or more sources without requiring mathematical modelling techniques.

The method of the invention provides a way to cost-effectively measure audiences in numerous applications regarding media distribution. It enables the implementation of an audience measurement system that, while having significant cost advantages over conventional methods and practices, can still produce quality audience data that reflects real and always-updated media consumption information obtained from real panels. The various steps are discussed below and six different application examples of the method are also presented below in more detail to illustrate its advantages and possibilities of utilization.

### Recording

Referring to steps 101 and 102 of FIG. 1, all known methods for measuring audiences to media broadcasts rely on recording media consumption information from a set of panel elements in a population. Panel elements may be of several kinds, including media devices monitored through appropriate metering apparatus, respondents wearing individual personal monitors, etc. In order to convey information on exposure status and content consumption choices made by users, each panel element is monitored by a respective metering system that records media consumption variables regarding exposure behaviour of involved respondents. Possible metering systems include set top boxes for measuring television audiences (e.g. peoplemeters, set meters, etc.), personal devices that can be worn by respondents (e.g. mobile phones running content identification software), monitoring software running on personal computers (e.g. resident Internet loggers), manual diaries to be completed by respondents, etc., etc. Measurement systems may rely on a variety of known methods to detect and report media consumption choices, such as tuner frequency measurement, embedded video or audio codes, image feature recognition, and audio or video signature correlation, amongst others. The information recorded from panel elements is usually called “elementary information” which comprises raw detection information as produced by the chosen metering system. Such elementary information may describe the content consumption choices made by a single respondent (e.g. mobile personal meters) or regarding a group of respondents (e.g. peoplemeters used in television audience measurement). In all cases, the information collected from the panel can be compiled into media consumption records that report the media usage of each respondent in the panel for a plurality of time periods (usually for every timeslot defined in the survey cycle) which in turn can be used to calculate audience estimates. Anonymous metering systems produce similar information about content choices, albeit of unidentified users.

The media devices used for media consumption in the context of the present invention may be of various types. These include devices such as a television set, an LCD display, laptop, PC, a mobile phone, etc. Possible types of media item consumed include video, audio, text, flash, or any combination of these, including all kinds of multimedia presentations like the ones available on Internet web pages. Media items may be accessed through a plurality of platforms such as satellite, internet, or ADSL line, and displayed via a media device. The term “screen” is generally used herein to refer to any kind of media device capable of rendering media items of some kind for a media consumer whether visual or otherwise, according to his or her media consumption choices.

FIG. 2a shows an exemplary audience measurement system comprising a panel 280 which includes a plurality of respondents 150 that have been recruited from a population for an audience survey. Respondents 150 are usually monitored on a continuous periodic basis in terms of exposure behaviour and content consumption choices. FIG. 2a depicts in particular a panel of metered devices in which respondents are monitored by metering respective screens 155 installed in respondents' homes. Demographic details of all respondents are usually known as well as additional contextual information about the screens used for media consumption (e.g. type of device, location, distribution platforms available, etc.). FIG. 2b depicts an exemplary audience measurement system comprising the same panel 280, while in this case respondents 150 are monitored individually using personal metering systems like wearable devices or mobile phones running specific software.

As shown in FIG. 3, an audience measurement system preferably comprises a computer system 100 equipped with a memory means 110 and arranged for execution of an instruction program 120, which realizes a plurality of logical and/or mathematical operations. The measurement system uses these operations to process information regarding media consumption behaviour detected for each respondent of a panel in order to produce audience estimates for the population. Demographic information available regarding each respondent is also involved in the production of audience estimates, so that the audience can not only be estimated in terms of total of persons consuming certain media items, but also demographic information that characterize media consumers (e.g. sex, age, family role, annual income, etc.). Each media consumer may be represented from a statistical standpoint as a combination of particular values of these variables.

FIG. 4 shows a simplified exemplary media consumption record 300 generated by a device meter (for example a peoplemeter used for measuring television audiences). Each line in the record describes the status (or a change thereof) of the metered device/s (e.g. content consumption choice made by the consumer/s). The exposure status of each associated respondent (e.g. family members) is also stated by records produced when they their presence or absence is detected (usually by declaration using a remote control).

Statements produced by device metering systems are then processed according to known statistical practices to produce a number of respondent records which state exposure status (if at all) and content items consumed by each respondent during each timeslot defined in the survey (typically all minutes in a day). FIG. 5 shows a simplified exemplary respondent media consumption record 310. Because personal metering systems bear a one-to-one relationship with respondents, they produce the same type of record for each monitored individual. It will be appreciated that records generated by device meters can be easily converted into individual records of the latter type (i.e. of the type produced by personal metering systems) by expanding the device information provided by the device meter with presence information regarding each individual involved in media consumption.

The panel 280 may be also composed of anonymous screens (like the RPD solutions or the “set meter” solutions described herein above) where detailed logs of commands executed on media devices are recorded although not including any information about the actual identity and number of individuals operating the media device. Hence, it is not possible to derive respondent records 310 from said devices; the records producible by such solutions comprise only media consumption statements without identity (“anonymous consumption information”).

According to known audience measurement practices, each metering device and each respondent is assigned a “weight” W. These weights are assigned and periodically adjusted in accordance with known statistical and audience research criteria to make the panel as representative as possible of the statistical universe it is assumed to describe.

### Affinity

Because both the mass and reference panels are independent but reflect media consuming habits of the same population, statistical events observed in one panel are mirrored by analogous observations made in the other one. Therefore, assuming both panels are properly balanced, any shares or distributions of media consumption variables, together with any correlation with corresponding variables, must be detected consistently in both panels. If the set of all relevant phenomena detectable in a given survey is divided in clusters, then the shares of such clusters in each panel must also be consistent. In other words, any given number of media consumption events belonging to a cluster detected in one panel is an indication of a proportional number of similar events occurring in the other panel.

Therefore, if such clusters are defined in terms of their correlation with any given variable, their shares must be consistent as well with the shares observed for the correlated variable in both panels. Hence, events belonging to the same cluster share a common statistical significance in terms of the correlated variable, and are therefore considered “affine” for the purpose of estimating such variables.

By way of example, if geographical location of media consumption events is considered to be relevant in estimating a certain variable (for example, the choice of media platform for watching television), then two media consumption events detected in the same geographical region may have the same significance with respect to that scope (i.e. estimating the usage of a media platform). On the other hand, if no significant correlation would be usually observed between the choice of media platform and the geographical location of the events, then the location becomes irrelevant in determining that variable, which means that there is no “affinity” between events occurring in the same regions (respect to that purpose).

Still by way of example, if the scope of a survey is obtaining only total audience for Internet websites (i.e. total Internet web usage), then all Internet consumption events are affine to each other (respect to that purpose), regardless of the visited URL or demographics of visitors. On the other hand, if the scope of the survey is providing total audience by genre (e.g. general news, finance, social networking, etc.), then all Internet consumption events detected at any website belonging to each genre become affine to each other, since they all share a common statistical significance regarding the audience of the respective genre. Therefore, any Internet consumption event within a given genre detected in one panel is indicative of a proportional number of affine events occurring in the other panel.

According to the present invention, audience information contributed by affine events detected in two independent panels are combined dynamically to produce richer audience information. Once the information about media consumption events has been recorded from both panels, affine events from both panels are identified and linked so that they can contribute supplementary information regarding media consumption.

In general, indications of affinity among events are derived from all information available about them. However, different media consumption events may have largely differing probabilities of occurrence. For example, audiences directed to television channels may produce share figures that differ in 3 orders of magnitude, within the same distribution platform. While media consumption events having a relatively low probability of occurrence in the population may be detected appropriately using a relatively large panel; using a small panel the same type of event is subject to sporadic detections in the form of statistical noise. However, detection of clusters of events can be done with comparable accuracy in both panels.

For example, in a particular application of the invention for measuring audiences to television channels, those achieving large audiences can be detected effectively in both panels, while very low-rated channels would probably provide very different figures (unless averaged over time) due to detection instability in the small panel. On the other hand, any arbitrary clustering of channels would produce sizable audience figures for each cluster in both panels, as long as clusters are large enough to be detectable with comparable accuracy in both cases.

Therefore, any given number of consumers that are detected in the large panel watching a low-rated channel implies a proportional number of consumers that “would be” detected in the small panel, albeit not all of them may be reported because of unstable detection. Regardless of whether all corresponding consumers are detected or not, their existence can be assumed in all cases since detection must converge consistently over a large number of observations. This means that every consumer detected in either panel is evidence of occurrence of all other affine events in its respective cluster in the corresponding proportion.

The criterion used for clustering events depends largely on the specific application of the invention. Clustering of event descriptions can produce stable indications of affinity between events, as long as the clustering and linking criteria are consistent. In other words, clusters must encompass event descriptions that share some statistical significance, so that events detected in either panel that are encompassed by the same cluster become affine by design.

### Session Space

The implementation of the invention can be described in most general terms on the basis of a “session space”.

Exposure to media takes place in terms of sessions, which are media consumption events involving one or more consumers and a given type of media for a given period of time during which at least some variables describing the event remain unchanged (e.g. using a single media distribution platform for a certain period of time). Therefore, a session can be described by a combination of media consumption variables defining a media consumption event from a statistical standpoint.

For example, a session may be described by media consumption variables describing the type of media device used for consumption, demographic variables describing the type and number of consumers involved in the media consumption event, contextual information like the type of environment in which media is being consumed (e.g. living room, bedroom, garden, workplace, out-of-home, etc.), the geographical area in which the media consumption event takes place, etc.

Media consumption phenomena can be described in terms of a multidimensional “session space”, wherein each dimension represents a different variable such as a media consumption characteristic used to describe a media consumption event involving one or more consumers and a media device. Each variable defining a media consumption event is mapped onto a different dimension of the session space, and each elementary media consumption event is mapped to a particular point in such space. Each set of coordinates in the session space therefore represents a particular type of media consumption event involving a media device and one or more consumers, which has a given probability of occurrence in the measured population (hereinafter a “session point”).

FIG. 6 shows a simplified, exemplary two-dimensional session space definition appropriate for describing media consumption events involving a single consumer (for example when measuring audiences through personal metering systems, based on wearable metering devices or mobile phones running content recognition software). The simplified exemplary session space of FIG. 6 describes the use of three different media; television, radio and internet. As shown in FIG. 6, one dimension (vertical) is used to represent basic demographic variables of the metered consumer (e.g. age and sex) and the other dimension (horizontal) is used to represent the type of media consumed. If, for example, annual income of the consumer (or of the family group to which he/she belongs) would be included as a relevant demographic variable involved in the survey, then a third dimension may be added to represent the various possible ranges of that variable in the population. Other variables may be considered in defining the session space, including family size, education level of consumer, geographic variables describing the location at which a session takes place, etc. etc. In general, any variable that is deemed of statistical significance in defining media consumption habits (and therefore useful to determine affinity among sessions), may be added to the session space mapped to an additional specific dimension.

FIG. 7 shows an alternative exemplary two-dimensional session space definition more appropriate when measuring audiences through the use of device metering systems installed in homes (for example, peoplemeter devices associated to TV sets and radio sets in the home). Because such metering devices produce exposure information for more than one consumer, it may be advantageous to group all possible combinations of demographic variables into clusters, in order to represent all possible combinations through a limited number of coordinates, according to their statistical significance (as shown in FIG. 7).

Variables involved in the description of media consumption events may be of two basic types: static or dynamic. Static variables regard aspects of the media consumption event that either do not change over time or that their rate of change is not significant respect of the time span of the survey. Examples of static variables are: 1) all demographic variables of consumers that are likely to be involved in the media consumption event (e.g. family members registered in the survey); 2) contextual variables like, household environment, geographic location, annual income of consumer, etc. On the other hand, dynamic variables are those variables that tend to change value during the course of media consumption. Examples of dynamic variables are: 1) actual status of a given media device (e.g. rendering media items or not), 2) actual presence of consumers (e.g. family members actually declared as “present” in a given session). A session space, as defined herein, may include both types of variables.

Program 120 runs in an iterative fashion, where each processing cycle spans a relatively short period of time (preferably not more than a few seconds long). In such context, any reference to a combination of variables representing a media consumption event is assumed to be temporal, spanning a short period of time, typically the one existing between two successive iterations of program 120.

### Exposure Space

Yet another concept useful for describing the processing required to implement the invention is the “exposure space”.

Each possible media consumption option available for consumers may be described as a combination of media exposure variables (such as a media distribution platform or content channel). Such combinations may be generally represented in a multi-dimensional “exposure space”, where media consumption characteristics such as all relevant media exposure variables describing the set of media consumption options available for consumers are mapped onto different dimensions of the exposure space, and each possible distinct combination of such variables becomes a coordinate (hereinafter “exposure point”) in such space.

According to the above definition, each possible coordinate in the exposure space (“exposure point”) represents one media consumption option available for consumers. Consequently, each elementary media consumption event occurring in the population can be interpreted as one or more consumers dwelling a particular exposure point for any given period of time. In the same way, in an audience measurement system based on device metering (e.g. television peoplemeters), the status of each metered device in the panel can be expressed in terms of exposure points dwelled (i.e. reported) by the metering device during any given period of time. This information is then converted to exposure points dwelled by each respondent that has been present in the media consumption event.

For example, in a measurement system for measuring television audiences from four possible platforms (e.g. terrestrial, satellite, cable and IPTV), a two-dimensional exposure space like the one depicted in FIG. 8 would be useful to represent any media consumption option available to a given respondent or device, one dimension representing the platform choice, while the second dimension would represent the choice of content channel. If media consumption devices offering time-shifting functionality would be included, then a third dimension in the exposure space would be useful to represent possible time-shift levels during consumption. Each possible choice of platform, content, and pre-determined time-shift available for potential media consumers becomes an exposure point in the exposure space.

Just like the session space, the exposure space may be grouped in predefined clusters to provide a higher level of aggregation through which those media consumption options can be classified according to their statistical significance respect to the scope of the survey.

In order to provide a high-level bridge for determining affinity between sessions (respect to exposure variables), exposure points are clustered in the exposure space according to, for example, distribution platform, type of media device used for consumption, time-shift range, content genre, or any other suitable clustering criteria. The term “domain” is used herein to refer to any arbitrary aggregation of exposure points in the exposure space. Domains should be defined in a given exposure space so that they bear no intersections, as a result of which each exposure point is encompassed by only one domain. So, for example, channels 6, 7 and 8 on a given satellite platform may be clustered as a single domain 400, as shown in FIG. 8, while other channels may be considered a cluster of only one element (for example channels 1 and 3, shown as residing alone in clusters 410 and 420 in FIG. 8).

In an enhanced embodiment of the invention, domain definitions may vary dynamically at each timeslot according to certain criteria. By way of example, different timeslots of a given television channel may belong to different domains, according to the content genre offered on the channel at different day parts. In the most general description, a different set of domains may be active at each given time boundary or timeslot. This approach may allow further savings in terms of panel size requirements since it tends to reduce the total number of domains. For example, large sets of exposure points of all rating levels could be nevertheless clustered according to genre offered at each half-hour of the day, so that at any given point in time there are as many domains as genres can be defined (and not more). However, it must be taken into account that such approach involves the additional burden of maintaining dynamic domain definitions according to pre-defined program schedules or observed changes in the media offerings of measured media sources, which would make it applicable only when given restrictions in the size of the reference panel would justify the extra work of maintaining dynamic domains.

It will be appreciated that the above definitions of “session space” and “exposure space” present a substantial resemblance. Indeed, both spaces could be combined in a single space that maps all relevant media consumption variables at once (i.e. consumption options and contextual/demographic variables). However, both definitions become useful in different applications of the invention, depending on the type of information available for determining affinity between sessions, as will become apparent further herein. The exposure space comprises all variables that regard content options available to a given consumer, while the session space describes contextual and demographic variables describing a media consumption event (usually not describing the available content options).

### Determination of Affinity

According to the method of the invention, at step 102 in FIG. 1 media consumption events detected in both panels that are deemed affine in terms of their statistical significance are temporally associated and artificial media consumption events are assembled by combining media consumption variables contributed by them. The indication of affinity is always temporal, and in relation to the given scope.

Both session and exposure information may be used to derive an indication of affinity, depending on the application of the method. In the context of this invention, the term “affine” is used to refer to media consumption events having a similar significance in statistical terms respect to a given scope. Such similarity may be expressed in a general fashion by defining classes of affinity involving media consumption variables mapped in the session and/or exposure spaces.

For example, two media consumption events may be deemed affine for a particular purpose if they share similar contextual and demographic information. By way of example, in one particular application of the method, two sessions might be deemed affine if they: 1) happen in the same geographical area; 2) involve the same number of individuals having similar respective demographic characteristics; and, 3) happen in homes having similar access to media (e.g. same distribution platforms installed). Such definition of affinity may be appropriate, for example, for determining sessions having similar probability distributions regarding the use of media platforms.

Depending on the size of either panel and the granularity required in the survey, exposure point information (e.g. content choices) may be used in combination or alternatively to generate a finer definition of classes of affinity, providing a more sensitive (and therefore more dynamic) indication of affinity. Including exposure point information increases the likelihood that sessions deemed “affine” will bear similar audiences, not only in terms of the variables already included, but in other demographic aspects as well.

In general, affinity may be determined by testing variables of media consumption events against a set of predefined rules of affinity. The rules are designed so that they cluster media consumption events that bear enough resemblance in their statistical significance, within the scope of the given application of the invention. For example, individual media consumption events detected through personal devices may be deemed affine to other events derived from group sessions detected with device meters (e.g. a television sessions detected by peoplemeters), but only when both metering devices are used to detect the same type of media exposure (e.g. “watching television at home”).

Classes of affinity may be as well defined extensionally, according to which session points or exposure points have been classified therein. This is particularly useful when using content information in class definitions. For example, in an application of the method for measuring consumption of cable television channels, theme channels may be clustered in domains by genre. In all cases, classes of affinity between media consumption events must be defined so that they bear no intersections, as a result of which each possible session point belongs to only one class.

For example, in an audience measuring system used for estimating television audiences, the method may be used to obtain usage figures regarding distribution platforms using a mass device panel equipped with simple metering devices that are only capable of determining the content items rendered by metered sets (without platform information), combined with a smaller reference device panel equipped with complete metering setups capable of determining platform in use. In such application of the invention, sessions detected in the mass panel are dynamically linked to affine sessions in the reference panel from which platform information is extracted and subsequently infused in associated sessions of the mass panel, to redeem the information obtained therefrom.

Furthermore, in some other application of the invention, it may be considered that the variable to be redeemed in the other panel may bear no significant correlation with any particular media consumption variable, and therefore no rules of affinity need to be defined in this case; the information contributed by one panel would be simply randomly infused in the media consumption information contributed by the other panel, as will be explained further in the related examples.

### Anonymous Affinity

In another example regarding an audience measuring system used for estimating television audiences, the method is used to obtain complete audience figures from an anonymous mass device panel (for example a cable television distribution platform with RPD capability). The demographic information is contributed from a relatively small reference panel equipped with complete metering setups, capable of recording the presence of consumers (i.e. respondents) in sessions. According to the invention, sessions detected in the mass anonymous panel are dynamically linked to affine sessions in the reference panel from which demographic information (i.e. presence of respondents) is obtained and subsequently incorporated or infused in associated sessions of the mass panel, to redeem the information obtained therefrom.

In such example, no actual demographic information is available from the mass panel (it is indeed the information that needs to be determined), therefore affinity must be determined in some other way. Some contextual variables may show correlation with the variable that needs to be determined (i.e. the presence of consumers in sessions), even though this alone may not produce indications of affinity strong enough to generate usable audience information. In such cases, the use of exposure point information may provide a better indication of affinity, since content consumption and demographic variables usually show a strong correlation.

For example, all cartoon television programs are more likely to be watched by the same audience profiles, which include mostly young children and some young parents. Music channels are likely to be watched by teenagers and young adults. Using content genre as a variable for affinity determination increases the likelihood that sessions deemed “affine” will bear similar audiences. In this way, domains can be defined in the exposure space clustering exposure points that share a common genre, which means that audiences detected on both panels dwelling exposure points encompassed by the same domain would likely bear a similar demographic composition in their audiences, and therefore represent affine media consumption phenomena, for that purpose.

According to an embodiment, the reference panel used is a respondent panel and/or the mass panel used is an anonymous panel.

### Affinity at the Respondent Level

The affinity of media consumption events can also be applied for measuring systems monitoring respondents using personal meters (e.g. mobile phones running specific software). In such cases, there is a one-to-one correspondence between metering devices and respondents. All concepts regarding affinity between media consumption events are equally applied; the difference being that the affinity rules regard media consumption variables describing individuals (as opposed to media devices).

In some applications of the invention, a mixed scenario is possible in which information generated by a panel of families is combined with information generated by a panel of individuals. Affinity rules are equally applicable by converting information recorded for metered devices into individual respondent records, so that media consumption events may be compared and (eventually) linked.

For example, in yet another application of the invention for measuring television audiences, a mass panel of respondents equipped with personal devices, capable of providing only information about content consumption (and, eventually, geographical position of the respondent) is combined with a reference panel of conventional peoplemeters equipped with means to determine many other aspects of television consumption (e.g. distribution platform, accurate exposure status determination, etc.). Program 120 expands first all device information recorded by peoplemeters into individual respondent records in order to enable meaningful determination of affinity among sessions (as depicted in FIG. 14).

### Consumption Time as an Indication of Affinity

All other variables being equal, the time at which a session occurs in either panel is implicitly taken as an indication of affinity. For example, two subjects exposed to the same television channel at the same time consume the same content; which is the maximum level of affinity achievable to the extent that content consumption is considered. However, the same two subjects consuming the same channel at very similar times of the day may also be considered temporally affine, depending on the scope of the survey.

For example, if the invention is used to enhance a system for measuring audiences to content offered through Internet web pages, a consumer that accesses content offered on a given web page at a certain point in time may be deemed statistically equivalent to another consumer having similar variables that accesses the same page at a later time during the same day; more so if the content offered by the page has not changed during that period of time.

In other words; valid links between reference and mass sessions can be produced even between sessions not happening “at the same time” but at similar times of the day, since statistical significance may be sustained even between media consumption events happening within a broad time span. Therefore, the “concurrency” of panels in the context of the present invention regards media consumption events detected at certain times such that the observation of such events reveal statistical correlation between them, in order to determine an indication of statistical affinity. In short, the term “concurrent” can be construed in the context of this document as: “occurring at statistically equivalent times”.

Affinity between Consumption Patterns

Further still, rules of affinity between sessions can be extended over the time line to comprise correlation analysis over a period of time spanning a plurality of consecutive media consumption events or session segments. For example, a succession of several different exposure points visited by a given panel element while swiftly switching content options repetitively over a short period of time (e.g. “surfing” over available television channels) may be classified collectively as a “surfing” session spanning the time period during which the situation persists, so that mass and reference sessions involving this type of media consumption pattern can be dynamically linked as if they referred to a single content choice (which could be called the “surfing” choice). In other words, panel elements detected in “surfing mode” over a few timeslots are linked to panel elements of the alternative panel that present the same consumption pattern at respective concurrent periods of time. In such embodiment of the invention, the rules of affinity encompass such cases and program 120 includes routines capable of determining affinity by analyzing similarity between strings of session points (as opposed to isolated sessions), determining a “similarity index” according to certain correlation indicators. By way of example, algorithms can be included in program 120 to perform calculations over series of exposure points in order to determine the Euclidean distance between predefined archetypes of a “surfing mode” and the media consumption information recorded for panel elements. Panel elements are then reported as visiting virtualized “surf mode” exposure points whenever the calculated distance between the actual series of exposure points and any of the archetypes drops below a predefined threshold.

### Linking

Referring to step 103 of FIG. 1, According to the method of the invention, the audience data contributed by both panels is blended by linking media consumption events (i.e. sessions) from both panels that show an indication of affinity. All sessions detected in both panels that belong to the same class of affinity configure evidence of a certain type of behaviour that has a probability of occurrence in the population. Links can thus be established between affine sessions of either panel so that more specific information about those media events can be cross-mapped to produce richer audience information.

To achieve this goal, at each timeslot program 120 identifies the class of affinity encompassing each media consumption event detected in either panel, by successively calculating an indication of affinity among all possible pairs of events. A linking process is then performed by program 120 that associates “stem” sessions from one panel to “target” sessions in the other panel, according to indications of affinity. Because affinity is a symmetric relationship, linking can happen in either sense; i.e. the invention may be implemented by program 120 processing mass sessions (stem sessions) and linking them to reference sessions (target sessions), or, processing reference sessions (stem sessions) and linking them to mass sessions (target sessions), obtaining comparable results.

In one preferred embodiment, program 120 links each session of the mass panel (i.e. stem sessions) to a respective session of the reference panel (i.e. target sessions). Because the mass panel is usually much larger than the reference panel, the linking occurs in a many-to-one fashion, i.e. a plurality of mass sessions is linked to each reference session. For example, in an application of the invention for measuring television audiences in an RPD scheme, the reference panel is made of peoplemeters fully-equipped to determine all possible relevant aspects of media consumption through television sets, while the mass panel is a large set of set top boxes with RPD capabilities (i.e. capable of reporting only commands executed by users). In such scheme, for every session detected in the mass panel, program 120 identifies all sessions of the reference panel that show an indication of affinity. This may be done, for example, by comparing all static information available for each session and determining compatibility thereof. Dynamic information (e.g. content genre) may be used as well, since such information tends to show a strong correlation with the likely audience profiles. Once all affine reference sessions have been identified, program 120 chooses randomly one affine reference session to be linked to the respective mass session. The random logic applied for linking ensures that media consumption information contributed by the reference panel (which includes TV On/Off information) is evenly distributed among all mass sessions, avoiding any bias. FIG. 9 depicts the linking process stemming from the mass panel towards the reference panel.

In an alternative embodiment of the present invention, the linking process is performed in the opposite direction; from the reference panel to the mass panel. In this case, program 120 links each reference session (stem session) to a number of mass sessions (target sessions). For every session detected in the reference panel, program 120 identifies all mass sessions that show an indication of affinity with the respective reference session. Once all affine mass sessions have been identified, program 120 chooses randomly a number of mass sessions to be linked to the respective reference session. The number of mass sessions to be linked can be determined by the relative weights of sessions detected in both panels, which are related to their relative sizes. The accumulated weights of all mass sessions linked to a given reference session must add up to the same nominal weight assigned to the linked reference session (approximately). In other words, the statistical weight originally assigned to the respective reference session is distributed among a number of affine mass sessions, in order to reflect as accurately as possible the statistical significance of the linked events. FIG. 10 depicts the linking process stemming from the reference panel to the mass panel.

The linking processes described herein above and depicted in FIG. 9 and FIG. 10 may be cognitively associated to the initial sampling process that precedes implementation of any audience research panel, and it will be referred to hereinafter by the term “meta-sampling”. The term has been chosen to reflect the fact that the sampling processes conducted dynamically by program 120 are targeted to a set of panel elements (i.e. families/devices/respondents) that have been originally recruited for the survey also through a statistical sampling process. In other words, the meaning herein of the term “meta-sampling” is: “sampling the sample”. Since the meta-sampling process is implemented by program 120 by processing the media consumption data obtained from the panels, the digital circuitry and software required for its implementation will be referred to herein as “Meta-Sampling Logic 400”, as depicted in the respective functional blocks of FIGS. 12b and 13b.

In a preferred embodiment of the invention, Meta-Sampling Logic 400 implements a more sophisticated sampling mechanism “without replacement” by which program 120 tries to link stein sessions to target sessions that have not been linked yet (or that have been least linked so far), in order to minimize the sampling error introduced by this stage of the method. Such enhanced random linking may be implemented (for example) by making program 120 keep track of the number of times each target session has been already linked at each given point in time, so that an eventual concentration of links is avoided, distributing links more evenly (albeit always randomly) across all affine sessions in each subset.

It will be appreciated that there are a number of different known ways of implementing software techniques for linking sessions, once affinity rules have been defined. In general, at every iteration of program 120, media consumption information detected for each stem session is processed to determine all target sessions from the other panel that fulfil the predefined affinity rules respect to the stem session, and then an affine subset of target sessions is formed, from which the actual links are drawn, according to the techniques described herein above.

Even though every link is temporal and subject to varying indications of affinity, program 120 should attempt to keep links alive for as long as possible to maximize stability in all aspects of the output data. In other words, links should be destroyed only when the affinity between sessions cannot be sustained as originally determined (for example, when either one of the linked sessions goes inactive). Any session that has been left unlinked must be re-linked immediately to any other available affine session, following the same random procedure used for all other links, in order to keep the output data appropriately balanced.

### Bonding Strategy

According to the present invention, linking is done dynamically according to temporal indications of affinity determined between sessions, what means that links are in principle valid for a relatively short period of time.

Audiences to media broadcasts usually evidence “loyalty” phenomena where there are certain respondents repetitively detected consuming the same content channels at the same times of certain week days. These behavioural patterns, which can be detected over relatively long periods of time in consumer exposure data, constitute “habit information”, valuable for planning or analyzing the impact of advertising campaigns, since it affects the balance between “reach and frequency” indications.

In a further enhanced embodiment of the invention, a “bonding strategy” is implemented by Meta-Sampling Logic 400, by which habit information gets reflected more accurately on the output data. A bonding strategy implemented within the linking process enhances the logic applied for creating links so that, under identical conditions, the same stem sessions tend to get linked to the same respective target sessions over time, so that consistent behavioural features are preserved in the output data.

An appropriate bonding strategy preserves a significant portion of the “habit information” detectable on panel elements without biasing the output data respect to the measured population. An optimum bonding strategy is one that, albeit using a fully random logic to create links, always maps stem sessions to target sessions in the same way every time program 120 is run under identical input conditions, so that two successive runs of the program provide indistinguishable results. It must always be verified for any valid bonding strategy that it does not introduce any biases nor it creates any internal cycles.

By way of example, program 120 may keep in memory a list of possible links which have been precompiled by program 120 for each stem panel element, according to static variables that are known for each respective mass panel element and each reference panel element. In other words, program 120 compiles a sorted list of potential links in which affinity between sessions has been partially pre-determined, to the extent that available static variables (e.g. contextual, demographic, etc.) allow doing so. The linking logic implemented by program 120 subsequently uses this precompiled list of potential links to attempt re-establishing one of those links when all other conditions are satisfied (e.g. given dynamic variables result in positive affinity determination).

In this example of bonding strategy, each precompiled list acts as a list of “preferred target sessions” for each respective stem panel element, and is sorted in descending order according to the preference assigned by program 120 (which is randomly determined). In this way, each time a new link needs to be established, the linking logic attempts first to link the respective target panel element to the top item in the list, and continues with the successive items in case of failure or incompatibility, and so on. If the list has been exhausted and no link has been established for any of its items (for example because none of the potential target sessions is currently active), the linking logic then falls back to searching randomly for a compatible session among all other affine target sessions. The precompiled list may be as long as desired to maximize the determinism of the linking process, although a significant amount of computing power might be required for processing it.

In other words, in the exemplary bonding strategy described above, program 120 attempts first to establish links referenced in the precompiled list (if all other applicable conditions are verified), and only when none of the links in the list can be established, then it searches randomly for any other suitable session. Since sessions continue to be chosen randomly (just like any session pointed by the precompiled list), there is no bias introduced in the meta-sampling stage respect to the represented population. However, the mechanism described above increases the probability of stem sessions being linked to the same respective target sessions over time, which partially infuses the “habit” information detectable in the panels into the output data. No bias is introduced with respect to the consumption habits represented in the output data, as long as the procedure used to create links in all cases is truly random.

Preferably, precompiled lists for all stem panel elements are kept by program 120 in persistent memory means provided by computer 100 (e.g. hard disk), so that the acquaintance between stem and target panel elements (as defined by the set of all precompiled lists) is applied across survey periods, increasing the stability over time of the “habit” information infused in the output data.

It will be appreciated by those skilled in the art of software design that there is a vast array of known programming techniques to realize the features described above regarding a bonding strategy. This stage of the method is particularly posed to be upgraded with future enhancements, in order to increase the benefits obtainable from the method of the invention.

### Assembling

Turning to step 104 of FIG. 1, as explained above, FIG. 4 shows a simplified exemplary meter record 300 generated by a device meter like a peoplemeter used for measuring television audiences. Each line in the record states the status (or a change thereof) of the metered device/s (e.g. content consumption choice made by the consumer/s). The exposure status of each associated respondent (e.g. family members) is also stated by records produced when their presence or absence is detected (usually by declaration using a remote control).

The processes run by program 120 for implementing the method of the invention are repeated at every iteration, spanning the whole survey time period, processing every session detected in the panels, looking for eventual changes in any previous status regarding sessions and links and handling any new situations, and reflecting them in the output data.

The assembling stage of the method is depicted schematically in FIG. 11. In order to reflect the information contributed by both panels in the output data, program 120 creates “proxies”, which are software representations of each monitored panel element (i.e. devices or individuals) from the mass panel 290 or reference panel 285. Being representations of panel elements, proxies may represent metered media devices (like for example television sets, or distribution set top boxes), as well as respondents (for example, when personal metering devices are used), or any other unit of measurement for which audience information is produced as part of the process. The set of all proxies constitute a virtual panel for which program 120 assembles artificial sessions for each panel element combining media consumption variables contributed by linked sessions. The set of all artificial sessions assembled for each proxy is then converted by program 120 into media consumption records of each respective proxy, which reflect all information available from both panels. The resulting database is used as a source of audience data of the population.

In one preferred embodiment of the invention, program 120 creates one proxy for each mass panel element, so that the mass panel is fully projected onto the output database. Such embodiment is depicted in FIGS. 12a and 12b. In such embodiment, program 120 copies most variables regarding mass panel elements onto the records assembled for respective proxies 160, and supplementary variables contributed by linked panel elements from the reference panel are infused in those records. The process is repeated for each timeslot of the survey and the resulting records assembled for virtual panel 292 constitute the output data for the audience measurement system as a whole.

For example, in an audience measuring system used for estimating audiences to internet websites, the method may be used to obtain audience figures using a mass panel made of JavaScript page tags conveying anonymous audience information regarding unidentified visitors to web pages, plus a reference panel using metering software installed in all computers in the reference panel to monitor access to web pages alongside with the identity of consumers (for example, through voluntary declaration).

Indications of affinity may be derived from a set of static variables (like for example household structure and income level, geographic location, etc.) plus some dynamic variables (e.g. content genre). Sessions detected in the mass panel are then linked to affine sessions detected in the reference panel, and demographic variables regarding known consumers of the reference sessions are infused in the anonymous session data contributed by their respective mass elements, in order to estimate the demographic profiles of their unidentified visitors.

Since audience and genre information are generally much less granular than content information (because the possible audience categories are just a few dozens, as well as the content genres, while the number of possible web sites visited by those users may range in the millions), a relatively small reference panel can still produce acceptably stable values for those variables. This reference information is then infused in respective proxy sessions associated to elements of the mass panel in order to obtain complete audience data therefrom.

In this way, the highly granular data regarding actual web page visits is contributed by the mass panel at a relatively low cost, while a smaller reference panel estimates the missing information. This information is not obtained from historic records or synthesized through a mathematical model; it is actually measured from a live panel, which assures the legitimacy of the audience figures obtained therefrom. Because the information is actually captured “in sync” from two representative panels, it is always updated and reflects actual phenomena occurring in the population.

The above example has been described in the simplest possible terms for the sake of clarity of the disclosure. It will be appreciated that such embodiment can be enhanced with more sophisticated processing including features like bonding strategies to increase the amount of “habit” information included in the output data.

### Assembling Sessions in Expansion Mode

The embodiment described above is appropriate when all information provided by the mass panel is to be preserved in the output data (i.e. all mass sessions are reflected in the output data). In this way, information contributed by the reference panel is used only to redeem the incomplete data provided by the mass panel. In other words, any additional information provided by the reference panel that cannot be linked to similar information provided by the mass panel is not included in the output database.

In some applications of the invention, the information contributed by the mass panel becomes useful only in the context of other audience information provided by the reference panel. In other words, the reference panel is used per se to produce audience data for a population, while the mass panel is used to enrich that audience information with more granular information contributed by the mass panel, when appropriate.

In such applications of the invention, an alternative embodiment includes an assembling mechanism called “proxy board”, which is depicted in FIGS. 13a and 13b. As opposed to the embodiment previously described, in the proxy board embodiment the reference panel leads the generation of audience data, while the mass panel is used to enrich the data produced by the former. The proxy board mechanism allows blending the media consumption information contributed by the mass panel and the reference panel into a single audience database, preserving most relationships between information items contributed by both panels.

The proxy board is a logic mechanism by which software representations of panel elements (i.e. proxies) are procedurally organized so that a plurality of proxies (as opposed to only one) is associated to each panel element of the reference panel (as shown in FIGS. 13a and 13b). Each reference panel element is “represented” by a group of ‘N’ proxies, each of which emulates most aspects of the media consumption information detected for its respective represented element. For this purpose, program 120 assigns a portion of the media consumption variables detected for its respective panel element to each proxy in each group at each timeslot defined for the survey. Such portion includes variables that describe events having a relatively high probability of occurrence in the population (i.e. high-level variables). For example, a variable describing consumption platform is usually a high-level variable since in most cases the platform options are a relatively low number, which means that each platform option has a relatively high probability of occurrence. Yet by way of example, content genre is usually a high-level variable since, in most content classifications, there are a limited number of genres, therefore each genre has a significant probability of occurrence. For this reason, distribution of high-level variables in a population can be estimated through relatively small panels. Such distributions get reflected in the proxy board as rows of proxies sharing the same high-level variables obtained from their represented reference panel elements. In other words, when a high-level variable describing a session detected in the reference panel changes, the whole row of respective proxies follows the change.

Every time there is a change in the high-level variables assigned to a row of proxies, each one of the proxies in the row is linked to affine sessions in the mass panel through the mechanisms explained herein above. High-level variables must be used in determining affinity between sessions. Artificial media consumption sessions are then assembled by program 120, blending high-level information contributed by the reference panel with more granular information contributed by the linked mass sessions. After all proxies in the row have been linked, each proxy row reflects as a whole the shares of low-level variables detected in the population by the mass panel, within each affinity class. By representing each reference panel element through a group of ‘N’ proxies (as opposed to only one), the reference panel “gets expanded” to allocate the finer audience information contributed by the mass panel.

Using the embodiment described above, high-performance metering solutions may be deployed in relatively small numbers to determine the high-level aspects of media consumption, while low-cost metering techniques can be still safely used in larger numbers to determine the low-level aspects of the same media consumption events, optimizing allocation of survey assets.

FIG. 13b depicts the proxy board concept in a block diagram fashion. Program 120 allocates a plurality of proxies 160 in memory means 110 of the computer system 100. Each proxy represents one metered panel element in the reference panel. One specific set of ‘N’ proxies is created for each respective panel element (proxy rows 165). Each one of proxies 160 is an instance of a data structure or object substantially similar to the one used to represent any panel element in a conventional audience measurement system, and can be considered a replication of the root panel element.

Preferably, the set of all proxies 160 comprising the proxy board 170 are procedurally organized in a two-dimensional fashion (as shown in FIGS. 13a and 13b) comprising R×N proxies, where R is the number of reference panel elements in reference panel 285, and N is the number of instances of proxies 160 created by program 120 for each one of reference panel elements 150 (N is an arbitrary number that may be determined according to certain criteria that will be explained further herein). Proxy board 170 acts as an artificial expansion of the reference panel 285. Any set of proxies 160 representing a single panel element is referred to as a “proxy row” 165. Each proxy 160 of any proxy row 165 is assigned a statistical weight W′ᵢ according to the formula: W′ᵢ=Wᵢ/N, where Wᵢ is the statistical weight given to the represented reference panel element 150. Therefore, while the size of proxy board 170 is N times larger than reference panel 285, the weight assigned to each proxy 160 is smaller by the same amount respect to its represented panel element, in order to preserve the significance of audience data generated for each proxy 160 accordingly.

At each timeslot defined in the survey, the session information produced by each panel element 150 is fed to the “Session Affinity Determination Logic 350” that applies predefined rules of affinity in order to determine subsets of mass sessions 296 that are affine to each detected reference session. Once the affine subset 296 has been determined (for each respective reference session), “Meta Sampling Logic 400” chooses one mass session to be temporally linked to each proxy in the proxy row 165, so that each reference session actually triggers N meta-sampling cycles.

The choice of N should be made taking into account that a larger N implies:
1. More resolution available to describe specific information contributed by the mass panel.
2. More computing power required for generation and analysis of the audience data obtained therefrom.

Furthermore it should be noted that if N is set too high with respect to other limiting conditions, only redundant data will be generated. As a general rule, N should be large enough to describe specific information with acceptable resolution. It must be taken into account that in most cases, at any given time, there will be a plurality of proxies spread out vertically across several proxy rows sharing similar media consumption variables who will be linked to affine sessions, which exploits to the maximum extent possible the actual resolution available from proxy board 170 as a whole.

Program 120 then generates media consumption information for each one of proxies 160 so that they emulate a portion of the media consumption data of their respective panel elements 150. For example, when any one of panel elements 150 is detected in a given session, program 120 creates information in memory means 110 copying a portion of the variables associated to the media consumption event on all media consumption records associated to proxies 160 along the respective proxy row 165 representing the root reference panel element. More specific variables of each artificial session generated for each particular proxy of the respective proxy row 165 will be infused from linked sessions detected in the mass panel. In this way, high-level consumption information contributed by the reference panel gets reflected in proxy board 170 along one of its dimensions (i.e. vertical dimension in FIGS. 13a and 13b), while the low-level information contributed by the mass panel gets reflected along the remaining dimension (i.e. horizontal dimension in FIGS. 13a and 13b).

The infusion of variables may be realized in full synchronization with the respective panel elements (reflecting changes at same corresponding timeslots) or alternatively within a predefined time tolerance to produce a more realistic emulation of a likely behaviour in the population, for example by reflecting changes at nearby timeslots through a normal distribution.

### Assembling at the Respondent Level

As explained above, the term “panel element” is used herein to refer to any unit of collection of media exposure data used in an audience measurement panel. For example, a metered television setup equipped with a peoplemeter may be a panel element, as well as a respondent equipped with some kind of personal meter (for example a mobile phone running some audio capturing software program). As depicted in FIG. 14, any media consumption event occurring in a population may be decomposed in elementary events involving one consumer and one media device.

Program 120 runs in an iterative fashion, where each processing cycle spans a relatively short period of time (preferably not more than a few seconds long). In such context, any reference to a combination of variables representing a media consumption event is assumed to be temporal, spanning a short period of time, typically the time existing between two successive iterations of program 120. It is useful then to introduce the notion of “session atom”, which is an elementary media consumption event involving one type of consumer and a temporal combination of media consumption variables. Using the above definition, any media consumption event occurring in a population may be interpreted in terms of session atoms. A group of consumers watching television together at the same time realize a number of session atoms, each of which reflects the exposure of one consumer. A relatively long media consumption event (where no variables change for a given period of time) realizes a consecutive sequence of session atoms, each of which represents the exposure of each consumer during the time units used by program 120 to process audience information. Any media consumption event involving (at least) a consumer and a media device can be interpreted as one session atom taking place in the population. The notion of session atom allows reducing all audience information detected in panels to a common unit, in order to enable linking of session elements that have been originated through different methods.

For example, in one application of the invention, a mixed approach is used by which information generated by a panel of families is combined with information generated by a panel of individuals. In such application, the exposure information generated by metered devices installed in participating homes is first converted to the respondent level (i.e. exposure information relating to each member in each detected session) and then linked to affine elementary sessions detected in the panel of individuals. FIG. 15 illustrates the same general concepts as FIGS. 13a and 13b, while in this case program 120 processes the audience information at the respondent level (session atoms). Such embodiment may be more appropriate when using personal metering devices (which monitor exposure of individuals to media content), or when the type of survey makes it more useful to process information about individuals instead of metered devices.

It will be appreciated that in all cases, the underlying principles of the invention apply, the only difference being the reporting and linking unit, which in this case would be the individual respondent together with the audience information produced for him or her in isolation. In other words, the panel elements in such case are respondents as opposed to metered media consumption setups.

A major advantage of the embodiment described above is that the audience figures obtained at the output through the proxy board reflect all media consumption of respondents (as opposed to reflecting only audiences belonging to the platform providing the mass panel). As long as suitable metering instruments and methods are available to reliably detect and report other media consumption situations existing in the reference panel, all exposure of panel elements can be measured at once. This is because actual media consumption is detected by the reference panel, while mass panel information is used only to determine shares of low-level variables within their respective affinity classes or domains.

By way of example, if the method of the present invention is used to measure television audiences for cable and terrestrial platforms, where the cable platform provides the mass data in an RPD fashion, all exposure happening in television sets that are not connected to a cable set top box may be measured and reported just as precisely as it would be done with a reference panel alone (where no set top box data is involved in the process). In other words, the information provided by the mass panel via set top boxes will only be mapped to reference panel elements that are reported as watching/rendering television content though the respective platform, not affecting any other elements that are reported as using other platforms to watch/render television content. If appropriate mass-reference mapping is done, only mass panel sessions (related to the cable platform) will be selected for linking with reference sessions that dwell any cable domain. In the same way, all other reference sessions may be mapped to mass sessions sharing the same respective platforms, or otherwise not mapped at all, which means that information obtained from reference sessions is simply copied on all respective proxies of the respective proxy row, hence reflecting the original respondent information on the output database without modifications contributed by any other panel.

It will be appreciated that the same is true for any number of distribution platforms used in the reference panel as long as suitable metering technologies exist and are made available to detect such exposure, so that a plurality of different mass panels may be used to enrich a single reference panel. As a result, the method of the present invention is easily extendable to provide a single-source audience measurement service, capable of reporting true cross-media consumption information.

For example, the method of the invention may be advantageously used to enrich information obtained from a given reference panel with information obtained from two or more mass panels that offer particular advantages (technical, economical or otherwise) in detecting specific media consumption variables respect to the reference panel, as shown in FIG. 18. Such mass panels (Mass Panel 290A and Mass Panel 290B in FIG. 18) are used selectively, so that information from each mass panel is switched-in according to the affinity criteria used for linking. In such case, the Session Affinity Determination Logic 350 includes software routines to determine affine sessions from more than one mass panel, according to the predefined affinity rules.

For example, in an application of the present invention for measuring audiences to television and internet pages in a “single source” fashion, Session Affinity Determination Logic 350 discriminates television sessions from Internet sessions happening in the reference panel and uses that media consumption information for dynamically determining affine sessions in respective mass panels. Proxies associated to respective respondents are then linked to corresponding sessions in respective panels, depending on the type of media consumption detected by the associated respondent.

### EXAMPLES

The following examples describe several applications of the invention for optimizing the use of survey assets in measuring audiences.

### Redemption of Mass Sessions

In most applications of the present invention, one panel is relatively large and produces incomplete audience information (mass panel), while the other panel is relatively small albeit capable of producing more complete audience information (reference panel). The reference panel is equipped with highly capable metering methods and the audience information obtained from it is used to redeem information obtained from the mass panel, which is equipped with a less capable metering system.

### Example 1

### Source Detection in Conventional Television Panels

In this particular example, the method of the invention is used in television audience measurement, where information obtained from a fully-equipped reference panel is used for infusing platform information in the data produced by a mass panel equipped with simple, low-cost peoplemeters that are not capable of detecting platform. The example is described according to the following parameters:

### Application of the Invention: Measuring Television Audiences—in Home

Population: 50,000,000
Reference panel technology: State of the art peoplemeters with platform identification capability
Reference panel size: 1,000 homes (2,500 television sets, circa)
Mass panel technology: State of the art peoplemeters without platform identification capability
Mass panel size: 5,000 homes (12,500 television sets, circa)
Platforms: 3, terrestrial, satellite and cable
Exposure Space: 30 channels in terrestrial platform, 300 in satellite and cable platforms

### Recording

Peoplemeters having platform detection capabilities usually require a wire connection to every peripheral in the measured TV setup. For example, a state-of-the-art television setup may include an LCD TV set connected to a DVD player, a VCR, a digital set top box (satellite or cable), and a game box. This means that a reference peoplemeter in this case must keep 4 wire connections to these peripherals in order to determine which of them is actually being used by consumers (i.e. which one is providing the content rendered by the LCD television set). A significant part of the costs of maintaining a panel in optimum working conditions are related to the fact that people tend to move, change and eliminate equipment connected to their TV sets, and this usually requires that the peoplemeter setup must be updated to monitor the new configuration correctly.

On the other hand, a simple peoplemeter may be built with current technology that does not require any connection to the television set (for example using content identification technologies that use audio matching techniques). Such a metering device can be installed by virtually anybody without any technical background, and in just a few minutes, and it would not require any updates even if the monitored TV setup is completely changed. The downside is that, because such metering device is not wired to the TV setup, it is typically not capable of determining the platform in use.

The present invention is used in this application by using simple, wire-less peoplemeters in most available TV setups (which become the “mass panel”), and using fully-equipped peoplemeters with platform identification only in a fraction of the available TV setups, which act as the “reference panel”. The scope is to reduce the panel maintenance and other operational costs, as well as the capital expenditure required to equip the whole sample.

The configuration depicted in FIGS. 12a and 12b is used (i.e. virtual panel in one-to-one correspondence to mass panel) and the linking method described in relation to FIG. 9 (i.e. mass panel stem, reference panel target) are both preferred in this particular application. In other words, the virtual panel is composed of a replication of panel elements in the mass panel (i.e. 12,500 proxies) and the platform information pertaining to each proxy is obtained from the reference panel (by meta-sampling). Media consumption information produced by the mass panel elements (i.e. simple peoplemeters) are replicated in the records produced for every proxy, leaving the platform information blank until it is fulfilled by information contributed by the reference panel.

### Affinity

The rules of affinity used to determining linkable sessions can relate to various aspects of media consumption. As explained above herein, the term “affinity” must be interpreted in the context of the variables that need to be estimated. In this example, sessions detected in both panels that would likely show the same choice of platform would be deemed “affine”, even if some other unrelated aspects of those sessions may differ significantly.

For example, the availability of a given platform is naturally critical in determining the use of such platform; therefore sessions detected in the mass panel in households known to have a satellite decoder cannot be determined “affine” to sessions detected in the reference panel in homes known to have access only to terrestrial channels (i.e. not having access to satellite channels).

Moreover, other dynamic variables may be relevant in determining the use of platforms. For example, the number and type of consumers present in any given session may show a strong correlation with the platform choice (all other variables equal). The location of the television set in the home environment may also be considered relevant. A session space definition similar to the one depicted in FIG. 7 could be used to represent all these variables facilitating the definition and verification of rules of affinity, together with their priorities. The particular choice of parameters (for example demographic cases, age ranges, etc.) are determined through statistical expertise and empiric analysis.

On the other hand, geographical location, even though it might play a role in determining content choices, it may be considered not relevant in determining the use of platforms (all other variables equal), and therefore it may not be taken into account in the determination of affinity.

Rules of affinity may include in their definition as well static variables regarding household annual income, number of household members, etc. It must be taken into account that the inclusion of too many variables in the rules of affinity may result in classes of affinity particularly small, which would tend to produce unstable linking, introducing noise in the output data.

### Linking

At every timeslot of the survey, program 120 checks all sessions detected in the mass panel and tests for any changes in their variables, as well as those of their linked sessions in the reference panel. For all those mass sessions in which changes have been detected (either in their own variables or on those linked to it), their “new” values are recorded and checked against all sessions detected in the reference panel, searching for affine sessions, according to the rules of affinity defined for the application.

After determining a subset of affine sessions in the reference panel, program 120 chooses one session to be linked to each mass session, according to methods described herein above regarding linking techniques (for example, using a bonding strategy).

### Assembling

The media consumption records generated for proxies (i.e. for mass sessions) are updated at every iteration of program 120 to reflect any new link status. In other words, the platform information detected in the linked reference sessions is infused in the media consumption records generated by program 120 for each proxy (i.e. for each mass panel element), in order to include as well platform information. The process is repeated for every timeslot defined in the survey until all sessions and all timeslots have been processed.

It is useful to analyze the errors produced in determining the platform information to provide a better understanding of the advantages of the invention.

The formula for estimating sampling errors is:

f1: ε=(1/p)*SQRT((p·(1−p)/n)

### Where:

ε is the expected relative error of the estimated value;
p is the expected proportion of “favourable” media consumption events detected in the panel (i.e. probability of observing a particular value regarding the variable under analysis); and,
n is the number of samples taken (i.e. number of panel elements);

It is important to note that, since the platforms available for television consumers in this example are only 3 (i.e. terrestrial, cable or satellite), and assuming the shares of each of these platforms are roughly 50%, 30% and 20%, respectively, the probability of detecting any active television set using any of the platforms at a given time of the day is significantly high for all platforms. In other words, because the set of all alternative values that the variable “platform in use” can take are very limited (3 in this case), and the probability of each value is comparable to all others (i.e. there is no significant concentration of probability for any particular value), a stable estimate of the share of each value can be obtained with a relatively small panel.

In fact, if the probability of a given TV set being active at that same time of the day would be (for example) 40%, then an average of 1,000 (i.e. 2,500×0.4) active TV sets would be detected in the reference panel. Assuming that most sessions would be tuning only channels that are available in all platforms (for the sake of simplicity), of those 1,000 TV active sets an average of 300 TV sets (i.e. 1,000×0.3) would be detected using the cable platform in the reference panel. The detection of those 300 cases using a reference panel of 2,500 panel elements is subject to a sampling error (using formula 1, with p=(0.4×0.3) and N=2,500) of 5.4%.

Therefore, the information about consumption habits (in terms of platform usage) existing in the population is reflected with acceptable accuracy in the reference panel. This information is then reflected on the virtual panel through meta-sampling.

Because both the mass and reference panels are independent but reflect media consuming habits of the same population, statistical events observed in one panel are mirrored by analogous observations made in the other one. Maintaining the same assumptions, an average of 5,000 (i.e. 12,500×0.4) active TV sets would be detected in the mass panel at that given time of the day. Their respective proxies will reflect exactly the same status (by design). Those 5,000 proxies will be then linked to the (circa) 1,000 panel elements in the reference panel that have been detected as being active, of which circa 300 will be reported as using the cable platform. Therefore, the process must detect those 300 cases out of 1,000, by taking 5,000 meta-samples of the information reflected in the reference panel. Therefore, the sampling error introduced by the meta-sampling stage (using formula 1, with p=0.3 and N=5,000) is 2.2%. Because the original sampling process used to constitute the reference panel is statistically independent from the meta-sampling process, the total error in the determination of the actual share of the cable platform through both sampling processes can be estimated as the RMS (“Root Mean Square”) of both error estimates, i.e.:

ε_{cable}=SQRT((0.054)²+(0.022)²)=5.8%

It is useful to compare the above result with the sampling error produced when detecting the share of ordinary channels though the mass panel. Assuming a channel ‘A’ would have a share of 5% at that same time of the day, then about 250 (i.e. 12,500×0.4×0.05) TV sets would be detected in the mass panel tuning such channel. Such detection would be subject to a sampling error (using formula 1, with p=0.4×0.05, and N=12,500) of 6.3%. Assuming a channel ‘B’ would have a share of 1%, such error would then be 14.1%.

It can be seen from the above results that the total error in determining the share of the cable platform in the above example is comparable with the sampling error introduced by a conventional system of comparable size when determining the share of channel ‘A’ (i.e. 5.0%, a major channel), while it is almost half of the uncertainty related to the share of channel ‘B’ (i.e. 1.0%, a medium channel). It is interesting to note that, if fully-capable peoplemeters (i.e. with platform identification capability) would be used in the whole mass panel (i.e. a conventional peoplemeter panel), then the sampling error in determining the platform share would be (using formula 1, with p=0.3, and N=12,500) of 1.4%. This means that, in such case, the significant extra costs of running a panel with full platform-identification capability would only provide the benefit of decreasing the sampling error related to platform identification by that amount (without improving the error related to shares of channels). Such noise level should be compared to the inevitable sampling errors associated with most small channels (i.e. 14% and beyond).

The utility value of this embodiment of the invention derives from the substantial savings that can be obtained from using low-cost metering methods (peoplemeters that do not require a connection to the monitored TV sets) in the mass panel, together with the capability of obtaining acceptable accuracy in the platform usage information.

### Example 2

### Estimating Demographics of Anonymous Panels

In this particular example of the method for television audience measurement, the mass panel is equipped with simple anonymous metering devices (not collecting demographic information), while the reference panel is equipped with fully-capable peoplemeter technology.

Anonymous meters are also called “set meters” because they are not equipped to capture presence of consumers (people data); they can report only content consumption choices made by unknown consumers.

### Application of the Invention: Measuring Television Audiences—in Home

Population: 50,000,000
Reference panel technology: State of the art peoplemeters
Reference panel size: 1,000 homes (2,500 television sets, 3,000 respondents, circa)
Mass panel technology: Simple meters without demographics or platform identification capability
Mass panel size: 5,000 homes (12,500 television sets, circa)
Platforms: 3, terrestrial, satellite and cable
Exposure Space: 30 channels in terrestrial platform, 300 in satellite and cable platforms

The interest in anonymous metering solutions for television audience measurement has been encouraged by the high cost of the alternative peoplemeter solutions and its declining response rates. The advantages attributed to anonymous metering include:
1) Lower operating costs (the hardware and installation costs less and the turnover is lower) affording larger panels.
2) Higher cooperation rates (it is simpler to install and therefore less invasive) resulting in better panels.
3) Greater respondent compliance (they are totally passive), resulting in better data and higher in-tab samples.

It has been estimated by Erwin Ephron that running a conventional peoplemeter panel may cost as much as 50% more than a simpler anonymous panel.

### Recording

The present invention is used in this application by using simple, set meters in the mass panel, and installing fully-equipped peoplemeters only in the reference panel, in order to realize the cost reduction attributed to anonymous meters. Therefore, the mass panel elements record and report only content consumption options made by implied consumers, while the reference panel elements are capable of recording most aspects of the usage of their respective television sets, plus the presence of consumers in consumption sessions.

The configuration depicted in FIGS. 12a and 12b (i.e. virtual panel having one-to-one relationship respect to mass panel) and the linking method described in relation to FIG. 9 (i.e. mass panel stem, reference panel target) are both still used in this example. In other words, the virtual panel is composed of a replication of the panel elements of the mass panel (i.e. 12,500 proxies). Media consumption information produced by the mass panel elements (i.e. set meters) are replicated in the records produced for every proxy, leaving the demographic and platform information blank (since these session variables are not obtainable from the mass panel).

### Affinity

Just like in the previous example, the rules of affinity used to determine linkable sessions can relate to various aspects of media consumption. However, the dynamic demographic information (i.e. who is present at the session), cannot be used here since this information is not produced by the mass panel (it is indeed the information that needs to be obtained from the reference panel). However, static information about demographic profiles of household members may be used advantageously. Dynamic information about content consumption is preferably used in this example, in order to produce stable and repeatable results. The notion of exposure space (described herein above) is useful for explaining this particular embodiment.

According to the above description, each possible coordinate in the exposure space (“exposure point”) represents one media consumption option available for consumers. Consequently, each elementary media consumption event occurring in the population can be interpreted as a panel element (i.e. a metering device, plus one or more consumers) dwelling a particular exposure point or domain for any given period of time.

In conventional methods used for television audience measurement, any single detection of a television channel in a respondent panel is taken as evidence of multiple consumers existing in the measured population who are watching the same channel at the same time. An analogous statement could therefore be done using exposure points, if audience information was reported in terms of exposure points visited by a consumer during a given survey period. However, it will be appreciated that in highly fragmented audiences, a single detection of an exposure point taken alone may not be significant since exposure points having a low probability of occurrence are subject to sporadic and discontinuous detections in the form of statistical noise. For example, a highly-rated channel on a terrestrial platform may usually be evidenced by a relatively large number of respondents detected as tuning that channel, while a low-rate, theme-specific channel broadcasted in a satellite platform might be evidenced by just one respondent detected at scattered periods of time.

To provide a bridge between the audience information produced by both panels, the media consumption information contributed by the mass panel is not considered at the exposure point level; instead it is interpreted at a higher aggregation level in terms of the domains dwelled by implied consumers during a given survey period. Working at a higher aggregation level may significantly increase the probability of detection, and therefore domain information can be used as a means for determining affinity of sessions. Generally stated, by aggregating exposure points, low-level exposure information that is detectable only in the mass panel becomes high-level “domain information” that is detectable in both panels with comparable accuracy, becoming useful as an indication of affinity between sessions (respect to the clustered variables).

As explained herein above, in order to provide useful indication of affinity between sessions, domains must be defined according to some statistically meaningful criteria so that all component exposure points share some common significance in audience research terms. For example, domains can be defined to cluster exposure points sharing a common genre, which means that audiences detected for exposure points encompassed by the same domain would likely bear a similar demographic composition. By way of example, all cartoon television programs are more likely to be watched by the same audience profiles, which include mostly young kids and some young parents. As a further example for measurement of television audiences, one set of domains may cover all channels belonging to a certain platform such as digital satellite, each particular domain grouping a cluster of channels sharing some common theme or genre. Therefore, all kids' channels within that platform could be clustered into a single domain defined as “digital satellite cartoons”. In addition, another domain may be defined to cover only one channel; i.e. a domain containing only one exposure point. This may be appropriate for major channels producing high ratings, since there is a high probability of respondents occupying this exposure point at any given timeslot. In such situation, clustering the exposure point with any other exposure points is neither necessary nor advisable. So, for example, channels 1 and 3 on satellite may usually achieve high ratings and therefore they are not clustered; they reside in their own private domains 410 and 420 respectively, as shown in FIG. 8.

Hence, domain information is used in this application as an indication of affinity between consumers reported in the linked reference sessions (on one side) and the implied consumers assumed to exist in mass sessions (on the other side). Because each known consumer in the reference panel is representative of a particular portion of the population in terms of media consumption habits, any distribution regarding domains observed in the mass panel is reflected as well in the reference panel, albeit in this case such information comes together with the demographic information associated to each domain. Such demographic information is subsequently blended in the virtual panel by meta-sampling, infusing such information into artificial sessions assembled for respective linked proxies. It must be taken into account that the stronger the correlation between domains and demographic profiles, the more accurate the demographic information infused in the output data.

As a general rule, domains should include not more exposure points than are necessary. The choice of domain definitions may produce output data that ranges from producing maximum stability on individual audience figures for all exposure points but conveying no demographic resolution (i.e. when only one domain is defined, demographics are reflected on the virtual panel without regard to content), to full demographic resolution with possible unstable linking for all low-rated exposure points (when each exposure point is contained in a single domain).

Besides the dynamic information regarding content, static information regarding the demographic composition of the homes may prove to be useful. In other words, although the metering systems installed in the mass panel are not capable of reporting the presence of consumers, information about the household members is indeed available at recruiting time and can be updated periodically at a very low cost (e.g. a phone call twice a year). This information can be compared to the same static information available for reference homes to further refine indications of affinity.

Furthermore, other dynamic information not regarding content may also be included in determination of affinity. For example, the location of the media device within the home (e.g. main TV set, kitchen TV set, 2^{nd} room desktop PC) or even the size of the TV screen (if available) may be used as other variables to further refine the determination of affinity (assuming panel sizes allow producing data with such granularity).

### Linking

Linking in this particular application is similar to what has been described above regarding example 1. At every timeslot of the survey, program 120 analyses all sessions detected in the mass panel and test for any changes in their variables, as well as those of their linked sessions in the reference panel, including domain information. For all those mass sessions in which changes have been detected (either in their own variables or in those linked to it), their “new” values are recorded and checked against all sessions detected in the reference panel, searching for affine sessions, according to the rules of affinity defined for the application.

### Assembling

The assembling of sessions in this particular application does not differ significantly from what is described regarding example 1. After determining a subset of affine sessions in the reference panel, program 120 chooses one session to be linked to each mass session, according to methods described herein regarding linking techniques. The media consumption records generated for mass sessions (i.e. for their respective proxies) are updated to reflect any new link status. In other words, the demographic information detected in the linked reference sessions is infused in the media consumption records generated by program 120 for each proxy (i.e. for each mass panel element), in order to produce complete records, including information regarding the presence of implied consumers (as well as other infused data supplied by the reference panel). The process is repeated for every timeslot defined in the survey until all sessions and all timeslots have been processed.

It is useful to analyze the errors produced in determining the demographic information to provide a better understanding of the advantages of the invention.

For that purpose, it is assumed that domains are defined in the following way:
1) One private domain for each major channel ‘A’, ‘B’ and ‘C’ (i.e. above 5% of share)
2) One private domain for each medium channel ‘D’, ‘E’, and ‘F’ (i.e. above 1% of share)
3) Domains defined for all theme channels, each domain representing 1% of total share (channels ‘G’ through ‘K’, ‘L’ through “Q’, etc.).
4) One domain clustering all other channels (‘R’ though ‘Z’).

In this way, when any mass session is detected tuning any major channel (i.e. ‘A’, ‘B’, or ‘C’) it will be linked only to reference sessions that are detected tuning the same channel (private domains have only one item in it). Assuming the share of active TV sets is 40% at a certain time of the day, and that channel ‘A’ has a share of 8%, about 400 TV sets (i.e. 12,500×0.4×0.08) will be detected in the reference panel tuning that channel, which will be linked to about 80 units (i.e. 2,500×0.4×0.08) detected in the reference panel in that same channel. The sampling error produced by the reference panel in determining the total share of channel ‘A’ (using formula 1, with p=(0.4×0.08), and N=2,500) is 11%, while the same number regarding the mass panel (N=12,500) would be 4.9%.

On the other hand, the probability of detecting individuals belonging to each category present in active sessions is relatively high. Indeed, the probability of a middle-aged woman present in an active TV session at some time in the early afternoon is relatively high in all homes in which there is at least one individual with those characteristics. Assuming, for example, that that class of family accounts for 60% of the sample, there would be about 600 homes in that class (i.e. 1,500 potential TV sets, of which 40% (600) are active). Assuming that such probability would be in the range of 50%, the sampling error in estimating the share of this phenomenon within that class of homes (using formula 1, with p=(0.4×0.6×0.5), and N=600) would be 11.1%, which is comparable to the error associated to the share of channel ‘A’.

It can be seen that, because the probability of individuals present in active TV sessions is relatively high, a small reference panel is capable of providing acceptably stable demographic information. Because channel ‘A’ is classified in a “private” domain in the exposure space, every session detected in the mass panel exposed to channel ‘A’ will always be linked to a reference session at the same channel. Therefore, the demographic information contributed by the reference channel in these cases is always “coupled” to the channel information.

For channels sharing a domain, the processing differs in that not every session detected in one panel consuming a particular exposure point will be linked with sessions of the other panel consuming the same exposure point; they will be linked with sessions consuming the same domain. If domains are defined so that they share similar demographic profiles in their audiences, this creates no significant differences.

For example, assuming channels ‘G’ though ‘K’ in the present example are clustered in a domain (called “GK” for simplicity), and the domain has a share as such of 2%, the total audience for the domain GK will be represented in the reference panel by an average of 20 sessions (i.e. 2,500×0.4×0.02), while on the mass panel this number would be around 100 sessions (i.e. 12,500×0.4×0.02).

Assuming that one channel in the domain (e.g. ‘G’) holds half of the domain's share (i.e. 1%) while the other half is spread over other domain components (which is a usual scenario), then each one of channels ‘H’ through ‘K’ would hold a share of about 0.25%.

In terms of sessions detected in each panel, these numbers result in:

| | Reference | Mass |
|---|---|---|
| | Panel | Panel |
| | Average | Average |
| Channel | Elements | Elements |
| Total | 20 | 100 |
| Domain | | |
| G | 10 | 50 |
| H, I, J, K | 2.5 | 12.5 |

It should be appreciated that the mass panel offers much more granularity to represent the internal shares in domain GK. Because the shares of channels H, I, J and K are very low, the number of expected sessions to be found tuning those channels in the reference panel becomes very low as well, what increases the probability in some cases of not finding any sessions at all in that channel (due to instability of low ratings). Should that be the case, there would be no session in the reference panel to link with the 12.5 (average) elements that would be found in the mass panel in those same channels. By clustering all those channels in one domain, a much more stable linking can be achieved (which brings stability to the demographic information imported from the reference panel), while the actual internal shares are preserved anyway at full resolution in the virtual panel (since this portion of the audience information is not meta-sampled).

The price paid for the enhanced linking stability are eventual demographic differences between the reference panel data and the virtual panel data for particular channels within the domain, which account for eventual variations in their specific demographic mix. The incidence of these variations is anyway confined within the boundaries of each domain. Moreover, the data produced at the domain level is nonetheless always as accurate as it can be for any given specifications regarding the reference panel, since everything that is true for a major channel continues to be true in such case as regards domains.

On the other hand, the accuracy of prior-art methods based on modelling presence of consumers depends entirely on the accuracy with which regression coefficients are calibrated. Because this information in these cases tends to be unstable (as discussed above), the only way to produce “accurate” coefficients is to average the results over relatively long periods of time, which rules out the possibility of reflecting unexpected or variable phenomena that can significantly affect the behaviour of the population as a whole (like for example, particular political situations, extreme weather, breaking news, etc.).

Unlike methods based on PIV modelling, the disclosed logic mechanism assures that any audience figures estimated by the method of the invention are a result of actual audience phenomena detected by real panels, while any temporal variations in the estimated shares are limited to natural sampling errors that introduce no biases and cannot be altered by modifying coefficients or formulas.

### Example 3

### Using Set Top Box Data

In this particular example of the method for television audience measurement, the mass panel is made of digital set top boxes used for distribution of content, running software capable of recording and reporting all commands executed by consumers (i.e. RPD). The boxes do not collect demographic information; they report only content consumption choices made by unidentified consumers. The reference panel is equipped with state-of-the-art peoplemeter technology.

Application of the Invention: Measuring Television Audiences—in-Home
Population: 50,000,000
Reference panel technology: State of the art peoplemeters with additional set top box status identification capability
Reference panel size: 3,000 set top boxes (7,600 respondents, circa)
Mass panel technology: Set top boxes capable of recording and transmitting usage data (“RPD”)
Mass panel size: 30,000 set top boxes
Exposure Space: 30 channels in terrestrial platform, 500 in satellite and cable platforms

### Recording

RPD set top boxes record “click stream” information comprising detailed logs of commands executed by media devices as they are operated. Each set top box acts as a metering device that provides information only about consumption choices and modes (e.g. channel tuned and time shift). The data produced by an RPD set top box does not include information about the status of the associated TV set (or other associated media rendering device). For example, the set top box does not know whether the television set to which it is connected is actually turned on, or if it is switched to some other input (such as a DVD player).

The configuration depicted in FIGS. 12a and 12b (virtual panel one-to-one correspondence to mass panel) and the linking method described in relation to FIG. 9 (i.e. mass panel stem, reference panel target) are both used in this particular application. Therefore, the virtual panel is composed of a replication of the panel elements in the mass panel (i.e. 30,000 proxies representing respective set top boxes). Media consumption information produced) by the mass panel elements (i.e. set top boxes) are replicated in the records produced for every proxy (what regards to media content options), leaving every other information plank (since content options is the only type of information obtainable from the mass panel).

The reference panel is composed of set top boxes of the same kind of those used in the mass panel, albeit the former are equipped with state-of-the-art peoplemeter technology capable of reporting information about usage of the set top box (e.g. if the set top box is actually feeding any content to the display device/TV set), as well as reporting presence of consumers. The information generated by the reference set top boxes is identical to the one generated by the mass set top boxes, although the former is merged at processing time with the stream generated by the associated metering device, in order to provide a complete picture of the usage of the set top box and the consumers using it in the reference panel.

The proxies composing the virtual panel must provide room to allocate all dynamic variables produced by a set top box (e.g. content options, time-shift level, interactive commands, etc.), plus all dynamic variables about the linked sessions contributed by the reference panel (e.g. status of set top box, status of display device/TV set, presence of panel members, etc.), plus any static variables associated to sessions of both panels. All media consumption records produced by program 120 associated to proxies represent the audience output information.

### Affinity

The rules of affinity used in this example are substantially similar to those disclosed for the previous example (2), what regards to exposure information (domains) used for determining affinity between sessions. However, because the status of mass sessions is in most cases uncertain or incomplete, this information cannot be used for determining affinity. Therefore, in this application, the panel elements to be linked are not metered TV sets, but the set top boxes themselves. In this way, the actual status of reference set top boxes (as detected by their associated peoplemeters) becomes reference information to be infused in proxy sessions to redeem the incompleteness (together with demographic information, as explained in the previous example).

It is generally accepted that any activity reported by the set top box is enough “proof” of the TV set being active and switched to the box. This convention is rooted in the perception that average consumers would not be “playing” with the box if they are not actually consuming content produced by it. However, there are many cases in which the set top box has not been operated for a relatively long period of time, and still there is an actual consumer using it (for example when watching a long film broadcast through that platform).

In RPD solutions (as described in the industry literature), this problem is tackled by modelling the activity of the set top box though so called “capping algorithms”. Such algorithms attempt to establish the probability that a session is not active as a function of the time elapsed since the last command has been executed (i.e. the “idle time”), plus many other variables that may affect such probability, like time of the day, day of the week, etc. Such capping algorithms rely on a plurality of coefficients that weight the role that each external variable plays in determining that probability. Each coefficient needs to be calibrated with historic information in order to assess its optimum value. The probability estimate is subsequently used to synthesize “TV off” statements inserted in the set top box data stream, in order to limit the lengths of sessions. As any other modelling solution, such approach has significant limitations, among which it is worth mentioning the impossibility of reflecting anomalous audience phenomena triggered by specific or unexpected events in the population.

The present application of the invention overcomes such limitations by obtaining the missing information from the reference panel through meta-sampling.

By way of example, at any given point in time in which a given set top box of the mass panel is reported tuning a certain channel (regardless of the actual activity status of the set top box), such tuning information (together with other known static variables) is used to find a subset of affine sessions in the reference panel (e.g. set top boxes tuning the same channel). Once the affine subset of sessions is identified, one session is chosen (randomly) from that subset and the activity status of the linked reference session (which is detected by the associated metering device) is then infused into the respective proxy session. The process is repeated for every mass session reported tuning the same channel. As a result, the ratio regarding “active”/“not active” sessions for that particular channel/domain (as captured by the reference panel) gets reflected in the mass panel for all sessions reported as dwelling the same exposure point. The process is further repeated for all other sessions in the mass panel.

The same rationale is used regarding domains, when processing mass sessions tuning low-rated channels. By way of example, assuming a domain “cartoon” has been defined, when a given set top box of the mass panel is reported tuning a cartoon channel, such domain information is used to find affine sessions in the reference panel, which then infuse their activity status into respective proxy sessions dwelling the same domain. In other words, every mass session reported to be tuning a given domain will be linked to some reference session dwelling the same domain, therefore everything that has been described above regarding channels continues to be valid respect to domains. The assembly process, however, is different in that the proxy sessions associated to each mass panel element retains its original channel information with full granularity. The domain information is hence used only for importing the missing information from the reference panel.

Because the process implemented by Meta-Sampling Logic 400 is essentially random, and the internal shares of channels within each domain are similar in both panels, the actual share of “active/not active” sessions respect to each channel within the domain gets reflected with satisfactory accuracy onto the virtual panel.

Furthermore, continuing with the example regarding cartoon channels, it is quite frequent that set top boxes that have been used in the evening by kids to watch cartoons are then left tuning those channels until next day, if no adults have used the set top box later during the same evening. If tuning were equated to audience, such phenomenon would create a systematic excess of reported audiences as “kids still watching cartoons in the late evening”. Yet, using a system built according to the present invention, those “residual” set top boxes tuning cartoon channels late in the evening are reflected in both panels in the same way, albeit in the reference panel the excess of audience becomes clearly isolated by the associated metering devices (which are capable of detecting the real session's status), and replicated in the proxy panel by the meta-sampling process, being automatically “tagged” at assembly time in the output data as “inactive sessions”.

Still continuing with the example, if in some rare occasion one evening there are a significant number of kids indeed watching cartoon channels until late hours, such phenomenon would still be captured by the reference panel and then reflected in linked mass sessions appropriately.

In this way, a system built according to the invention can capture all statistical phenomena (not just long-term averages) and report it with adequate resolution, without resorting to predictive analytics. No calibration is required and the information produced is factual and accurate (to the extent allowed by the given reference and mass panel specifications).

### Linking

Linking in this particular application is similar to what is described above regarding example 2. At every timeslot of the survey, program 120 would analyze all sessions detected in the mass panel and test for any changes in their variables, as well as those of their linked sessions in the reference panel, including domain information. For all those mass sessions in which changes have been detected (either in their own variables or on those linked to it), their “new” values are recorded and checked against all sessions detected in the reference panel, searching for affine sessions, according to the rules of affinity defined for the application.

### Assembling

The assembling of sessions in this particular application does not differ substantially from what is described regarding example 2, except for the fact that the actual status of a proxy session is left blank until such information is provided by the linked reference session. In other words, although the mass sessions are unable to provide status information, they provide content information that is linked to the reference panel to obtain the missing variables.

A numeric example will be useful to further clarify this application of the invention and is advantages.

Assuming that, at a certain time of any weekday afternoon, a given channel ‘A’ has a share of 8% of all set top box sessions, then about 240 sessions (i.e. 3,000×0.08) will be detected in the reference panel tuning that channel. The sampling error produced by the reference panel in determining share of channel ‘A” can be estimated (using formula 1, with p=0.08, and N=3,000) at 6.2%.

In the same way, about 2,400 sessions will be detected in the mass panel in that same channel. The sampling error produced by the mass panel in determining share of channel ‘A” can be estimated (using formula 1, with p=0.08, and N=30,000) at 2%.

Assuming as well that the reference panel detected that only 95% of sessions tuned to channel ‘A’ are actually active (the “active ratio”). Then, from all the 240 sessions detected, only 228 sessions are reported as active. The error in the determination of the active ratio can be estimated considering that the 95% figure is analogous to finding 228 favourable cases over 240, which yields 1.5% (using formula 1, with p=0.95, and N=240).

However, in this case the mass panel is not capable of providing that information; it must be imported from the reference panel by meta-sampling. This means that the active ratio of 95% (i.e. 228/240 reference sessions) will be meta-sampled by the 2,400 mass sessions, which introduces a meta-sampling error of 0.5% (using formula 1, with p=0.95, and N=2,400).

The total share of channel ‘A’ reported by the system as a whole will be given by the number of “active” sessions in channel ‘A’ found in the assembled sessions for the virtual panel. Such number is the product of the channel share determined by the mass panel (which should be around 8% as explained above), multiplied by the active ratio contributed by the reference panel. All three figures convey their own errors to the final figure, but because all noise processes are statistically independent, the total error in the determination of the actual share of channel ‘A’ can be estimated as the RMS (“Root Mean Square”) of all three error estimates, i.e.: ε=SQRT(1.5%)²+(0.5%)²+(2%)²)=2.5%. It can be seen that such combined error is comparable to the error that would have been produced by the mass panel alone, if the set top boxes would be capable of providing the full picture.

In a preferred embodiment of the present application of the invention, the determination of affinity is further enhanced to include the “idle time” in the calculation (i.e. the time elapsed since the last command detected in a set top box, which is derived from dynamic content information produced by set top boxes). In other words, the idle time is included as one more variable describing exposure (i.e. it may be included in the exposure space), so that such variable is involved in linking sessions from both panels.

Consistently with other applications of the invention disclosed herein and in order to obtain stable linking, possible values of idle time are grouped in clusters according to session lengths. The statistical affinity of sessions showing similar idle times does not need clarification. By way of example, idle times could be grouped according to the following scale (‘T’ stands for idle time):
a) T<=15 min
b) 15 min<T<=30 min
c) 30 min<T<=60 min
d) 60 min<T<=120 min
e) 120 min<T<=240 min
f) 240 min<T<=480 min
g) 480 min<T

Such scaling of idle times produces 8 different clusters, which may provide an appropriate granularity, depending on panel sizes.

As explained above, in conventional RPD solutions such variable is used to cap long sessions according to a modelled algorithm. In the present embodiment of the invention, that variable is used to link mass sessions to reference sessions, so that linked sessions are more likely to provide the right status indication to their respective affine sessions. In other words, all other variables equal, sessions in which activity is detected in their RPD data tend to be linked with sessions showing a similar pattern, and sessions that have not changed status for a certain period of time tend to be linked with sessions that show signs of inactivity in their data. The distribution of active/inactive status actually detected in the reference panel (through respective metering devices) respect to the “idle time” variable is then reflected through this relationship on affine sessions of the mass panel, further improving accuracy of the linking process.

### Example 4

### Integrating Set Top Box Data in Currency

As explained herein above, in some applications of the invention, instead of using information produced by the reference panel to redeem mass panel sessions, the reference panel is used in this case to produce audience data per se, while the mass panel contributes with more granular information enriching the data produced by the reference panel. Such arrangement is appropriate when information contributed by the mass panel becomes useful only in the context of other audience information provided by the reference panel.

In this example of application of the invention, a mass panel composed of set top boxes with RPD capabilities is used, while the reference panel is composed of state-of-the-art peoplemeter setups, capable of detecting any use of the monitored TV set or display device, including the use of set top boxes of the same distribution platform as the mass panel.

In the present application, the present invention is implemented to improve the measurement of low-rated satellite television channels, according to the following parameters:

### Application of the Invention: Measuring Television Audiences

Platforms: Terrestrial and Digital Satellite
Reference panel technology: State of the art peoplemeters
Reference panel size: 4,000 TV setups
Mass panel technology: Set-top box data
Mass panel size: 50,000 set top boxes
Exposure Space: 20 channels in terrestrial, 300 in satellite
Domains: One for each major channel in each platform, Satellite domains according to channel genre

### Recording

The reference panel is monitored by complete metering devices capable of detecting all usage of TV sets and associated set top boxes, as well as presence of known consumers (recruited for the survey).

The mass panel data is collected through its own RPD resources. Set top boxes of the mass panel record information of all commands issued by unidentified users.

The configuration depicted in FIGS. 13a and 13b (virtual panel as a “proxy board” arrangement) and the linking method described in relation to FIG. 10 (i.e. reference panel stem; mass panel target) are used in this particular application. The virtual panel is a proxy board composed of a replication of reference panel elements (i.e. proxy rows). Media consumption information produced by each reference panel element (i.e. by the monitored TV setups) is replicated in the records produced for all respective associated proxies.

When reference metering devices detect usage of the associated TV set that is not fed by the associated set top boxes, the information collected by the metering devices is simply copied in respective proxy sessions. On the other hand, when the associated set top box is detected as being the source of the content rendered by the respective monitored display or TV set, then the information provided by the mass panel is used to enrich the data produced by the reference panel through meta-sampling.

### Affinity

The rules of affinity used in this example are analogous to those disclosed regarding the previous examples (2 and 3), although linking in this case is applied only at those times in which the reference session involves a set top box. In other words, only reference sessions that report use of a set top box are linked to mass sessions; all other sessions (e.g. watching local terrestrial TV or using a DVD player) are naturally considered not affine to any mass sessions and therefore are not linked. Exposure space information is particularly indicated in this case since the mass panel is anonymous.

The discussion regarding the use of “idle time” indications as a linking variable is also relevant in this case, since the equipment used in the reference panel is capable of determining activity of the set top box, while the mass panel lacks this capability. Using the idle time as a linking variable tends to improve precision and stability of the output data.

### Linking

The linking process in this particular example is substantially different from what has been described regarding previous examples. The main difference is that the proxies in this case do not represent mass panel elements; they represent reference panel elements (see FIGS. 13a and 13b). Another main difference is that reference panel elements are not associated to proxies on a one-to-one basis; each reference panel element is associated to as set of ‘N’ proxies (i.e. proxy row) that replicate most aspects of the media consumption information produced by their respective represented reference panel elements.

According to the present application of the invention, at every timeslot of the survey program 120 analyzes all sessions of the reference panel (which are replicated by proxies) and test for any changes in their variables, as well as those of their linked sessions of the mass panel. For all those sessions in which changes have been detected (either in their own variables or on those of sessions linked to it), their “new” values are recorded and program 120 checks is existing links have been invalidated by the changes. For all those sessions affected by changes, and for new sessions reported by the reference panel, program 120 searches the mass panel for new affine sessions, according to the rules of affinity defined for the application. Once each subset of affine sessions has been identified, each proxy of each proxy row associated to a modified or new reference panel element is linked to one affine session of the mass panel, which is chosen randomly from each respective subset. In other words, in this linking scheme, all proxies in a given row belong to the same affinity class by definition and must be linked to the same subsets of mass sessions, on a row-by-row basis, in order to reflect distributions of linked variables detected in the mass panel within each given row. Links are maintained between proxies and mass sessions consistently with the rational described above.

### Assembling

The proxy board allows assembling proxy sessions through a logic mechanism, blending all information contributed by both panels (depicted in FIG. 13b).

Program 120 defines the media consumption variables of each proxy session according to the values contributed by respective reference panel sessions. Such variables would include all variables produced by the reference panel, except for the lowest-level information. Program 120 subsequently infuses exposure point information onto the proxies sessions (i.e. in their respective exposure records), so that these are reported as visiting the same exposure points dwelled by unidentified linked consumers in respective mass sessions.

According to this embodiment of the invention, the information detected for each monitored session taking place in the reference panel is derived into two streams (as depicted by FIG. 13b): 1) a first stream that conveys information about the actual existence of sessions in the reference panel, which is reflected uniformly along the set of proxies representing each reference panel element (i.e. proxy row 165); and, 2) a second stream conveying high-level sessions information, including domains dwelled by the respective reference panel element, which is used by Session Affinity Determination Logic 350 to determine subsets of mass sessions reflecting similar media consumption situations in the measured population. It will be appreciated that because links are created randomly between proxies and mass sessions, the shares of exposure points detected for sessions of each subset 296 are reflected in an unbiased manner onto each respective proxy row representing each panel element. In this way, assembling is effectively done in two phases; a first phase that replicates high-level media consumption information contributed by the reference panel onto all respective associated proxies, and a second phase in which low-level media consumption information contributed by affine mass sessions is infused in linked proxy sessions in order to enrich the information recorded for proxies with more granular data detected by the mass panel.

A numeric example is useful to further clarify this application of the invention and its advantages.

According to this example, if at a certain timeslot the share associated with a given satellite channel ‘A’ is 0.1%, and given that there are 4000 reference panel elements, 4 elements would be detected in average on channel ‘A’ during that timeslot, with an expected sampling error of 0.15 share points (i.e. 50% relative error). This means that in roughly 95% of cases, the actual audience detected will vary between almost 0.0% and 0.2%, which means in turn that between 0 and 8 elements will be reported in that particular exposure point. In most cases, a panel of 4000 elements is deemed not appropriate for providing acceptable stability in reporting low-rated exposure points, due to the inevitable jitter produced by sampling error.

On the other hand, using an audience measurement system according to the present invention, that same channel ‘A’ would be clustered with other channels in a domain. One possibility would be to cluster channel ‘A’ with other channels offering content of the same genre (for example “cartoons”) and therefore sharing as well similar audience profiles. Continuing with the example, channel ‘A’ could be clustered with another 4 channels (‘B’, ‘C’, ‘D’, and ‘E’) whose associated shares (at that same timeslot) could be ‘B’: 0.2%, ‘C’: 0.3%, ‘D’: 0.8% and ‘E’: 1.6%. The domain clustering all five channels of this example may be therefore referred to as “cartoon domain”.

In such scenario, adding the shares for all the component exposure points, the total share for the cartoon domain would be 3% of reference panel elements. Therefore an average of 120 elements would be reported as watching that domain at that same timeslot, with an expected sampling error of 0.27 share points (i.e. 9% relative error). This means that in 95% of the cases, the actual detected audience for that domain will vary between 2.46% and 3.53%, which in turn means detecting between 98 and 142 elements dwelling that domain. It can thus be seen that the sampling error associated with a domain as a whole can be significantly lower than the one associated with any of its components, depending on the number of components and the share contributed by each component.

Continuing with the example, if ‘N’ would be chosen equal to 100, the total number of proxies (in proxy board 170) would be 400,000 (i.e. 4,000 respondents×100); while the average number of proxies reported as dwelling the cartoon domain would be 12,000 (i.e. 120 elements×100). Internal shares within the domain are resolved through meta-sampling, reflecting the shares of components over those 400,000 proxies.

In order to estimate the total error in determining audiences, two additional sources of sampling errors need to be considered: a first source given by the intrinsic sampling error produced by the mass panel, and a second source provided by the meta-sampling stage.

Regarding the first source, and assuming the size of the mass panel is 50,000 elements (i.e. set top boxes), the sampling error associated to channel ‘A’ (0.1% of audience share) is around 0.0141 share points (i.e. 14.1% relative error). The sampling error associated with the whole cartoon domain (3.0% of audience share) would be 0.073 share points (i.e. 2.5% relative error). If both variables can be considered independent and uncorrelated, then the combined error in determining the internal share of channel ‘A’ as a quotient between both shares can be estimated by calculating the RMS (root mean square) of these two values, which is in this case: 14.4%. It will be appreciated that this is an approximation, since variations in the numerator does in fact modify the denominator, albeit slightly.

To estimate the error introduced by the meta-sampling stage, it is useful to consider that an average of 1500 elements from the mass panel would be identified by Domain Identification Logic 350 as dwelling the cartoon domain (i.e. 3% of 50,000). Of those 1500 elements, about 50 elements would be detected tuned to channel ‘A’ (i.e. 0.1% total share, 3.3% internal share). Those 1500 elements would be then randomly linked to each set of proxies representing each reference element (which in this case is 100 proxies for each element) over a total of 12,000 proxies (approx.). This means that 12,000 proxies all together will “meta-sample” those 1,500 domain mass elements to reflect the internal shares of all components of the cartoon domain, including those 50 mass elements expected to be tuned to channel ‘A’. The sampling error then associated to the meta-sampling process can be interpreted as analogous to detecting an audience share of 3.3% through a panel of 12,000 respondents, which would yield a sampling error of 0.16 share points (i.e. 4.9% relative error).

In this case, since the number of total proxies in the domain is much higher than the number of mass elements found in the same domain, each mass element ends up being linked to more than one proxy (in this case 8 proxies per mass element), which means that significant redundancy is produced in the output data base. This is not a problem, since only internal share information is required from the mass panel. On the contrary, the higher the number N is, the lower the sampling error introduced by meta-sampling becomes, albeit increasing the computing power required for producing and analyzing the audience data.

The total sampling error in estimating the audience of channel ‘A’ in this example can be estimated considering that all three sampling processes are coupled in series towards the output. In other words, the total audience for a certain channel (exposure point) at any given timeslot is the product of the domain share provided by the reference panel, multiplied by the internal share of the channel provided by the mass panel, where the “product” in this case is performed by a digital logic process (i.e. meta-sampling) that introduces further noise in the output data. Since all three processes are independent and uncorrelated (regarding the generation of noise), the total error introduced may be estimated by calculating the RMS value over their respective contributions, i.e. ε_{T}=SQRT((12.7%)²+(31.6%)²+(9.8%)²)=35.5%.

If only sampling errors respect to the low rated channel of the example (channel ‘A’) are taken into account, a comparable result would be obtainable through a conventional respondent panel of 32,095 elements. An audience measurement system as the one described above uses set-top box information advantageously to produce significant cost savings, yet not relying on predictive analytics.

There is one additional source of error that must be considered in the determination of the internal shares, which can be referred to as “demographic mismatch”, which becomes more evident when analyzing data regarding restricted demographic groups. Since the information contributed by an anonymous panel reflects general shares when all demographic groups are taken into account as a whole, these may differ from the actual shares that exposure points may have in specific demographic definitions. This is true only if certain components within a given domain may be more appealing to a certain demographic group than other components of the same domain. This is why the homogeneity of domains (in terms of audience profiles of component exposure points), plays a major role in determining quality of the output data. The greater the similarity of the audience demographic profiles of component exposure points within any given domain, the more accurately internal shares of its component exposure points will be reflected on the output data.

One useful criterion for defining domains is clustering channels so that all domains obtain at least a minimum share threshold, in order to keep the level of data quality in relation to each channel's share. For example, all channels (or exposure points) having large expected shares may be allocated in separate “private” domains in order to preserve the maximum data quality level available for a given respondent panel size. Lower-rated channels may be clustered according to genre or theme to provide the best possible match in terms of audience profiles among components, while a few larger domains are defined to encompass all other very-low-rated channels, which otherwise would have no chance of being reported consistently, should a conventional respondent panel be used. It is assumed that, in many real-world applications, the loss of granularity in demographic information would be offset by the advantage of significant cost savings that a system according to the present invention can provide.

### Example 5

### Single-Source Measurement TV and Web

The present invention can be applied to advantageously in measuring exposure to more than one type of media, using a single reference panel. For this purpose, the reference panel must be equipped with all necessary monitoring devices and methods in order to capture reference information regarding all measured media platforms. The present example describes an application of the present invention for measuring consumption of television and web pages in a “single source” fashion.

### Application of the Invention: Measuring Audiences to Television and Web Content

Population: 30,000,000 individuals
Platforms: Various television platforms, Internet web pages
Reference panel technology: State of the art television peoplemeters, metering software for monitoring web usage
Reference panel size: 10,000 respondents, 20,000 TV sets, 3,000 browsers
Mass panel ‘A’ type: Anonymous set top box data (“RPD”)
Mass panel ‘A’ size: 20,000 set top boxes
Mass panel ‘B’ type: Server logs from major web sites
Mass panel ‘B’ size: NA
Exposure Space: 300 television channels, 30 major web sites
Domains: One for each major television channel and each major web site, genre domains defined for minor satellite/cable channels, sub-domains defined in each major website according to website page map
N (proxy board depth): 200

Besides installing peoplemeters in all monitored TV sets or displays in recruited homes, also monitoring software is installed in all computers used by every panel member. The reference panel provides the frame (high-level) consumption information, while separate mass panels contribute with more specific consumption information, as required. The process is depicted in FIG. 16.

Such additional burden level on panel members in most cases increases the churn rate of the reference panel, what must be compensated by more incentives for panel members. This makes even more necessary to keep the size of the reference panel as small as possible, yet compatible with the accuracy specifications of the survey.

The configuration depicted in FIGS. 13a and 13b (virtual panel in the form of a “proxy board”) is used, in this case using the particular embodiment depicted in FIG. 16 (multiple mass panels, switched by Session Affinity Determination Logic 350). Even though data is contributed by different panels using diverse methods, linking is done at the device level, since the audience information produced in both cases is compatible at most levels. In other words, both peoplemeters and resident software for tracking web usage are associated to a device (not to a respondent), and both report exposure to content by declared users.

The linking scheme described in relation to FIG. 10 (i.e. reference panel stem; mass panel target) is used in this application, albeit in this case several mass panels are involved in the production of audience data. The virtual panel is a proxy board composed of a replication of reference panel elements (i.e. either TV setups or browsers). Media consumption information produced by each reference panel element is hence replicated in the records produced for all respective associated proxies (see FIG. 15), which are as well artificial representations of reference panel elements.

When metering devices used in the reference panel detect media usage that is not related to any of the available mass panels, the information is simply copied in the respective proxy sessions (i.e. no supplementary specific information is contributed by any panel). On the other hand, when reference panel elements are reported to be exposed to areas of the exposure space for which supplementary audience data is available from one of the mass panels, then the information provided by the respective mass panel is used to enrich the data produced by the reference panel element, by meta-sampling through its proxies.

### Recording

All television sets used by panel members are equipped with state of the art peoplemeters capable of reporting all usage of monitored television sets. The peoplemeters provide as well presence information regarding panel members (i.e. recruited respondents).

The metering software used for monitoring web usage in the reference panel is capable of detecting URL addresses accessed by metered computers, using any of the known methods available for that purpose. Such software is capable as well of reporting presence of panel members (e.g. by declaration).

The television mass panel (“mass panel A”) is composed of a large number of television decoders (set top boxes) having RPD capabilities (producing anonymous consumption data), as explained in relation to example 4.

The web mass panel (“mass panel B”) is not recruited as such; it is implied by the usage information collected by servers. Because web servers are (in principle) universally accessible, they can be assumed to reflect the media consumption habits of the whole population (in terms of browsers). Therefore the implied mass panel in this case is equivalent to the whole population.

At the end of each survey period (typically whole days), all information recorded by mass panels (i.e. set top boxes and log servers) are shipped to a processing centre through appropriate communication means (e.g. public phone network or Internet) and made available to program 120 for processing, together with the information produced by the reference panel.

### Affinity

The exposure space offered by the web is divided in several domains; one for each web site participating in the survey, plus one great domain aggregating all other unclassified destinations. Sub-domains are then defined for all participating web sites clustering pages or content items by genre, type, site map area, or any other clustering criteria. It is essential, however, that domains do not overlap. The granularity with which activity within any participating web site can be described depends on the site's average audience as well as the average audience achieved by each particular site subdivision (as imposed by sampling size limitations). The size of the reference panel determines the minimum web site audience that may justify a participation in the survey. For example, very small web sites may not have audiences large enough to be detected consistently in the reference panel, which can cause sporadic detections and make linking unstable. In any case, being the present example a single-source system implementation, only those web sites achieving shares comparable to those obtained by the measured television channels should be included, for the sake of consistency.

The anonymous exposure information provided by log servers is used to enrich the information provided by the reference panel, in a similar fashion as what has been explained herein above in relation to RPD implementations. In other words, sub-domains within participating web sites are treated analogously as domains in the television platform respect to the channels contained therein.

Because access to web sites does not happen according to the same dynamics that can be observed in television consumption, the portion of affinity rules that regards to web exposure may be different from the rules used for determining affinity between television sessions. Most of the web content is offered in terms of “pages” or “clips”, which are discrete pieces of content (of various types) that are rendered “on demand” according to user choices. Unlike content offered by a television channel, web content usually does not change on a second by second basis; it tends to stay unmodified available for all users for a relatively long time (e.g. one day, one month or longer, depending on the application). Therefore, as explained herein above, a session detected at content offered in a given page at a certain point in time may be deemed affine to another session having similar variables detected at the same content but at a different time of the day.

Therefore, the affinity rules used for web sessions should use a wider time span for analyzing sessions. As explained above herein, the rules of affinity must be designed in the context of the particular type of information required from meta-sampling. In this case, such information includes at least: the demographics of visitors and the specific exposure points visited within each domain. In such context, the particular time at which a user consumes content within a web site becomes useful only if expressed in a low-resolution time scale, which—in meta-sampling terms—is equivalent to clustering the consumption variable “time” in respective domains. Therefore, the domain of all possible consumption times in a day may be clustered, for example, in quarter hours or half hours, to provide a more meaningful and stable indication of affinity.

The rules of affinity used in this example must also take into account in this case that a plurality of mass panels are involved, so that platform information must be used for linking to respective mass panels.

### Linking

The linking process in this particular example is similar to what has been described regarding the examples 4, in that the proxies represent reference panel elements, which in this case refer to TV setups or browsers. As explained in those examples, each reference panel element is associated to a set of ‘N’ proxies that replicate most high-level aspects of the media consumption information produced by their respective panel element. For example, variables representing the media platform in use (i.e. TV or Internet) and the particular domain (within that platform) dwelled by the reference panel member are both always replicated on artificial sessions of the entire respective proxy row.

According to what has been explained herein before, in the present application of the invention program 120 analyzes all sessions of the reference panel (which are replicated by proxies) at every timeslot defined in the survey and looks for any changes in their variables, as well as those of their linked sessions of the mass panel. For all those sessions in which changes have been detected (either in their own variables or on those of sessions linked to it), their “new” values are recorded and program 120 checks is existing links have been invalidated by the changes. For all those sessions affected by changes, and for new sessions reported by the reference panel, program 120 searches the respective mass panel for new affine sessions, according to the rules of affinity defined for the application. Once each subset of affine sessions has been identified, each proxy of each respective proxy row is linked to one affine session of the respective mass panel, which is chosen randomly from each respective affine subset. The process is continued and links are maintained between proxies and mass sessions, consistently with the rational described above.

Preferably, browsers used to visit the participating web sites are “tagged” by use of “cookies”, which allows identifying the terminal (browser or computer) used to access the site. This allows implementing a bonding strategy to preserve habit information as explained herein above. The location of the visitors (as can be deducted from IP addresses) is preferably included, which may be used as static information in determining affinity for increasing the linking precision.

Because in this case exposure to more than one media platform (e.g. television and web) some differences exist respect to the way information is collected in both cases, which has an impact in the linking rationale.

For example, metering systems used for measuring television audiences usually provide accurate information about the exact time a user has spent consuming a particular channel or platform. Such information is not always available from web metering methods, since there is no clear indication that somebody has finished consuming content offered by any given web page. In other words, because content is not offered and consumed on a second-by-second basis as it is the case in television platforms, there is no certainty about the lengths of sessions when measuring web exposure, since such variable depends entirely on users' habits (i.e. no metering system can detect automatically when a user has finished reading a web page).

Some assumptions then need to be made about the length of web sessions to avoid undetermined variables and therefore inappropriate linking. For example, a simple and useful assumption is that mass sessions are as long as linked reference sessions require. In other words, any mass session that is linked to a reference session is considered active for as long as necessary in order to keep providing information to its respective proxy (i.e. associated reference session). Such assumption certainly creates mass sessions that differ in lengths respect to their real ones, although such inaccuracy does not affect the actual exposure time because this is determined by the reference panel exclusively. The mass sessions are used only to determine shares of component exposure points within domains.

### Assembling

The proxy board allows assembling proxy sessions through a logic mechanism that blends all information contributed by both panels (depicted in FIG. 13b).

Program 120 maintains the media consumption variables of each proxy according to the values contributed by respective reference panel sessions. Such variables would include all variables produced by the reference panel, except for the lowest-level information, which is subsequently contributed by respective linked mass sessions belonging to respective mass panels. Program 120 assembles artificial sessions for all proxies 160 infusing exposure point information on their respective exposure records, so that these are reported as visiting the same exposure points visited by unidentified consumers implied by respective sessions detected in the mass panels.

A numeric example is useful to further clarify this application of the invention and its advantages. Numbers do not reflect any real measured data, but just a hypothetical situation useful for the example. All web sessions are assumed to involve just one individual (as it is typically the case) for the sake of simplicity. All web activity is measured as pages downloaded by domestic visitors within each hour of the day.

Assuming that a domain is defined clustering four newspaper websites (the “newspaper domain”), and that its four components hold the following average internal shares within their domain (as evidenced by the page downloads denounced by their log servers):
1) News A: 75%
2) News B: 15%
3) News C: 8%
4) News D: 2%

Assuming as well that at a certain time of the day, the following situation is consistently evidenced by the reference panel:
1) 30% of individuals watch television
2) 5% of individuals browse the internet (within the hour)
3) 5% of surfers dwell the newspaper domain.

Therefore, at that time of the day, the following figures would be detected in the reference panel:
1) 3,000 individuals watch television (error: 1.5%)
2) 500 individuals browse the web (i.e. 10,000×5%) (Error: 4.1%)
3) 25 individuals dwell the newspaper domain (i.e. 500×5%) (Error: 19.9%)
4) 18.7 individuals browse the “News A” website (Error: 23.1%)
5) 3.7 individuals browse the “News B” website (Error: 52%)
6) 2.0 individuals browse the “News C” website (Error: 71%)
7) 0.5 individuals browse the “News D” website (Error: 141%)

It can be appreciated that the reference panel is able of measuring the total audience of the newspaper domain with acceptable accuracy, although it is not appropriate for measuring the smaller components of the domain.

On the other hand, if the mass panel is considered to be the whole population (given that their websites are universally accessible), then the internal shares shown by the activity in their log servers reflect the actual shares. Since the reference panel shows that the total audience of this domain (at that time of the day) is in the range of 0.25% of the population (i.e. 5%×5%), the sum of all log servers should evidence a number of total activity consistent with that figure, i.e. 75,000 page downloads circa, for the whole domain.

According to the present invention, this dynamic mass panel of 75,000 web sessions (i.e. page downloads) will be meta-sampled by all proxies dwelling that domain. This means that the error with which the mass panel is capable of determining the internal shares of the newspaper domain is:

News A=0.2% (using formula 1, with p=0.75, and N=75,000)

News B=0.9% (using formula 1, with p=0.15, and N=75,000)
News C=1.2% (using formula 1, with p=0.08, and N=75,000)
News D=2.6% (using formula 1, with p=0.02, and N=75,000)

It can be appreciated that the errors produced by the mass panel (which in this case is theoretical) in determining internal shares is, in this case, about two orders of magnitude lower than the reference panel. The mass panel is not required to determine total audience for the domain as a whole, since such figure is determined with acceptable accuracy by the reference panel. Because shares must be reflected identically in both panels, once the total number is determined by the reference panel, the mass panel contributes with more granular information within each domain.

In order to complete the error analysis, the error introduced by meta-sampling needs to be determined. In that sense, assuming N=200, the number of proxies dwelling the newspaper would be circa 5,000 (i.e. 25×200). Those 5,000 proxies are linked to the circa 75,000 sessions evidenced by the domain log servers in order to reflect the internal shares of components. The errors introduced by meta-sampling can be estimated using formula 1 with ‘N’=5000, as follows:

### News A: 0.8%

### News B: 3.4%

### News C: 4.8%

### News D: 9.9%

As explained herein above regarding previous examples, the total errors for each case, considering that all noise processes are substantially independent, are calculated as the RMS value of all three values:

### News A: RMS(19.9%, 0.2%, 0.8%)=19.9%

### News B: RMS(19.9%, 0.9%, 3.4%)=20.2%

### News C: RMS(19.9%, 1.2%, 4.8%)=20.5%

### News D: RMS(19.9%, 2.6%, 9.9%)=22.4%

It is interesting to note that, because the dominant error is provided by the reference panel in determining the total share for the domain, the total errors in determining shares is very similar for all domain components.

One major advantage of the present application of the invention is that all these figures are generated by the system alongside with the audiences of other websites and TV channels, large and small, utilizing a single reference panel of conventional size (respect to those used in measurement of television audiences).

### Example 6

### Using Mobile Phones to Produce Granular Television Audience Data

This particular example shows an application of the present invention to cost-effectively measure audiences to television programs using portable personal meters (such as mobile phones).

As explained above, much has been debated about the capability of mobile phones panel technology to provide audience estimates of acceptable quality. One of the key drawbacks of such technology is the impossibility of guaranteeing uninterrupted channel reporting because of possible background noise that makes it impossible detecting exposure to media for certain periods of time. Another significant disadvantage respect to traditional peoplemeter panel technologies is the lower cooperation rates among respondents, given the request of carrying the capturing device all the time while they are in their homes. The lower cooperation rates create further interruptions to the reporting of exposure to content, which affects the reporting of viewing behaviour for each respondent, and therefore for the population as a whole.

However, the idea of using mobile phones to measure exposure to television and media in general has been gaining ground within the industry for being potentially a cost effective alternative compared to traditional peoplemeter panels, due to lower capital expenditures and maintenance costs.

The present invention can be advantageously applied in this case to constrain the inevitable limitations of a mobile phone panel by combining its audience data with a reference panel measured with more sophisticated peoplemeter technology, according to the following parameters:

Application of the Invention: Measuring Television Audiences—in-Home
Population: 50,000,000
Reference panel size: 1,000 individuals
Reference panel technology: State of the art peoplemeters
Mass panel size: 10,000 individuals
Mass panel technology: Mobile phones equipped with suitable content recognition technology
Mass Panel Rejection Factor: 25%
Channels: 20 channels in terrestrial, 300 in satellite
Dimensions of session space: Distribution platform plus age, sex, and annual income of consumers.
N (proxy board depth): 200

### Recording

The reference panel is installed with peoplemeters which are capable of accurately letecting the times at which the measured television devices are turned on or off, the platform in use, plus, identifying the consumers (the panel members present in consumption sessions).

The mass panel instead does not use equipment connected to television sets; every respondent in the panel is equipped with a mobile phone running software capable of detecting exposure to content. For the reasons explained above, sessions detected in the mass panel must be strictly scrutinized to exclude from the survey those sessions/respondents that do not comply with certain quality rules. For example, respondents not complying with cooperation requests may be suspended from the sample until they can be contacted to attempt an improvement in their compliance levels. Also, sessions that show too many interruptions in the content recognition process may be temporally excluded from affinity classes so that they are not linked to any proxy, preventing low-quality data from reaching the output stream. The effective number of usable mass sessions will be always lower than the installed panel. It can be assumed for the purpose of this example that the average rejection factor is 25%, therefore only 75% of the session data coming from the mass panel is actually usable for audience measurement, which is equivalent to considering an effective panel size of 7,500 respondents.

The information obtained from a conventional metering device (such as a peoplemeter) would usually include:
1) Information about the length of the session (i.e. times at which the measured television set is turned On and Off) (high-level);
2) Contextual information further describing the viewing session (e.g. “home viewing”) (high-level);
3) Times at which available platforms are in use (high-level);
4) Presence information regarding consumers (who are members of the continuous panel survey) (high-level);
5) Information regarding a series of content consumption choices made by the consumers (e.g. content channels tuned by the measured television device, together with their times) (low-level);

The most relevant variable determined by the reference metering system is the actual existence of the session and its start-end times. Because there is a relatively high probability of finding television sets in use (mostly during certain times of the day), this indication has a high probability of detection; therefore it is considered a high-level indication.

Contextual information would usually be static respect to a given television set. For example, session 500 (FIGS. 17 and 18) is indicated as happening “at home”. Since most television viewing happens within the home boundaries, this indication is considered high-level as well.

### Affinity

The rules of affinity are based on the high-level information recorded for both panels. In this case, the session information is broken down to the respondent level, since the mass panel can produce only this type of session information. This means that all session information is converted into session atoms (involving individual consumers exposed at the same session at each given timeslot) so that a plurality of individual sessions (i.e. session atoms) is derived from each reference session (see FIGS. 14 and 15).

At each given timeslot, the mass panel information is searched for affine session atoms, which are depicted as subset 296 in FIG. 15. All information obtained from the mass panel is processed concurrently with the information obtained from the reference panel to find similarity among high-level variables in both panels, so that session atoms from both panels can be associated. Because demographic information is relatively high-level and is available from both panels, it is particularly effective in determining affinity between sessions. For example, all session atoms that involve a man 42 years old detected in the reference panel are deemed affine to any session detected in the mass panel showing the same demographics (all other variables are equal), and therefore are linkable.

Content information (i.e. domains in an exposure space) may be added further for affinity determination if sample sizes are large enough. This may be particularly useful for very-low rated channels (e.g. satellite or cable channels).

### Linking

The linking process described in FIGS. 13a and 13b is used in this example, combined with the process depicted in FIG. 9 (stem reference sessions linked to target mass sessions). This is because the frame-like, high-level information is necessary to determine total audience levels and this is produced reliably only by the reference panel; therefore most variables are contributed by such panel. The mass panel is used only to determine shares of channels within each class of affinity. By way of example, at any given time there are 100 individuals belonging to a certain demographic category detected consuming television in the reference panel, in a certain region. Those 100 individuals should be mirrored by circa 1000 individuals belonging to the same demographic category (provided that both panels are appropriately balanced and representative) detected in the mass panel consuming television as well. The shares of all participating channels should be as well mirrored in both panels. However, the mass panel is ten times more numerous and therefore is capable of providing much more granularity in determining the shares of channels, mostly regarding the low rated channels. Linking is then performed (in such situation) between those 100 individuals detected in the reference panel with those 1000 individuals detected in the mass panel, according to the techniques described herein above. The linking granularity depends on the actual affinity rules defined. In other words, as more granular criteria is used for defining affinity, more granular becomes the linking process, which needs to be balanced with the level of repeatability expected from the audience data produced by such a system. Implementing a bonding strategy is deemed particularly appropriate in this type of application of the invention, since linking in this case tends to become quite granular.

### Assembling

In a conventional scheme, all audience information is generated by metering devices connected to respective TV sets and used by the same respondents (as depicted in FIG. 17).

According to this application of the invention, session atoms are detected at each given timeslot in the reference panel, and their high-level information is copied in each associated proxy. Affine session atoms are subsequently detected in the mass panel, and artificial sessions are then assembled for all related proxies, combining the high-level information obtained from the reference panel (e.g. TV in use, at home, cable platform, demographics) with low-level information contributed by the mass panel (i.e. specific content choices detected in a relatively large number of affine mass session atoms). Links between both types of session atoms are maintained for the longest possible times (i.e. as long as their respective high-level variables do not change) in order to keep as much flow information as possible in the output data. As depicted in FIGS. 17 and 18, session 500 would usually take place over a relatively large number of iterations of program 120, which means that links may be updated quite frequently in such a scenario. FIG. 18 depicts the rationale of the processing that takes place in program 120 when measuring the same session 500 of FIG. 17.

Since detection from mobile phones cannot be guaranteed to be uninterrupted (by interference produced by disturbances, or by lack of cooperation from respondents) only those sessions deemed to carry valid audience data are included during each search for affine sessions. The status of each mass session is refreshed dynamically at each given time slot, in order to maximize efficiency in the use of available survey assets. The information coming from the mass panel will still carry any inevitable limitations of the method used for detection (e.g. content identification interrupted by background noise, inaccurate definition of session limits, etc.), but because such limitations tend to affect all channels in the same way, it does not affect significantly the share indications obtained from the mass panel. High-level variables defining each session are still safely determined by more accurate methods in the reference panel.

It may be useful to analyze the errors introduced in each phase of the method according to the given set of parameters, in order to better explain the advantages of the invention in this particular example.

For the sake of simplicity, the numeric example that follows will be done for the whole population (all demographic categories at once) and for only one platform. It will be appreciated that a similar logic can be applied regarding any particular demographic category and any number of platforms.

At some given point in time there might be (for example) 30% of the population watching television in respective home environments. This means that an average of 300 respondents in the reference panel will be detected as watching television at that same time. Using formula 1, the sampling error for estimating the total television audience would be in the range of 4.8%. This means that in 95% of cases, the total number of reference respondents detected as watching television will be within 271 and 329.

If the same panel would be used to detect exposure to a channel having an average share of all television viewing of 1% at that same time of the day (hereinafter “channel A”), the average number of reference respondents tuning that channel would be 3. The sampling error respect to that variable would be around 57%, which means that in 95% of the cases the actual number of reference respondents detected on that channel would fall between 0 and 6. It can be seen that panel sizes that may be sufficient to determine high-level session variables with acceptable accuracy, may not be useful (usually) for determining other low-level variables of the same type of session due to the significant difference in the respective probabilities of detection.

According to the present application of the invention, once the proportion of the population watching television has been determined through the reference panel, the actual share of channel ‘A’ (−1%) will be instead determined by the mass panel, which can hold a much larger number of respondents given the higher affordability of the technology used, and the significantly lower operating costs. It must be taken into account that, in this example, the mass panel holds 10,000 respondents using mobile phones, which can be acquired at relatively low prices and do not need to be connected to any TV set, which significantly reduces the maintenance costs traditionally associated to metered equipment.

At that same time of the day, there would be an average of 3,000 respondents watching television (i.e. 30%), of which about 2,250 will produce valid audience data at any given time (i.e. rejection factor assumed at 25%). This means that it is assumed that 750 respondents that will be watching television, although it might happen that they might not hold their respective device close to them (as requested to detect exposure), or the environmental background noise might be too loud to allow correct identification of the channel tuned in the television set (therefore no valid content choices can be reported), or the phone's batteries may be exhausted (therefore it is not operating), etc.

These phenomena, however, would not affect any particular channel on a permanent basis; instead it is a random disturbance that reduces the overall reporting level without significantly affecting share indications. It is assumed that the cost in terms of panel management required to keep the reporting levels according to more traditional standards would offset the extra cost created by the unusable portion of the panel data.

From those 2,250 individuals in the mass panel producing valid data, it is expected that an average of 22 respondents (1%) will be detected watching channel ‘A’. It can be seen using formula 1 that this number would bear a relative error of 11.5% (i.e. in 95% of the cases the number would fall between 17 and 28).

In order to estimate the total error in determining audiences in this example, an additional source of sampling errors produced by the meta-sampling stage needs to be considered. In fact, these 22 individuals will need to be “meta-sampled” into the proxy board, which in this case would hold 200,000 proxies (1,000 reference respondents×200), of which 30% will be reported as watching television at that particular period of time (i.e. 60,000 proxies), in accordance with exposure information detected in reference respondents. The situation is analogous to estimating the actual share of a phenomenon that has a 1% chance of occurring in the mass panel by taking 60,000 samples, which would bear a sampling error (using formula 1) in the range of 4.1%.

In this case, since the number of total proxies is much higher than the number of mass respondents found in compatible sessions, each session ends up being linked to more than one proxy (in this case 26 proxies per session), which means that significant redundancy is produced in the output data base. This is not a problem, since only share information is required from the mass panel. On the contrary, the higher the number N is, the lower the sampling error introduced by meta-sampling becomes, albeit increasing the computing power required for producing and analyzing the audience data.

It will be appreciated that several enhancements may be made to the Meta-Sampling Logic 400 described herein using known software techniques, for example by using a more sophisticated logic to sample mass screens “without replacement”, in order to minimize the sampling error introduced by this stage of the process. If such enhancements are implemented, a significantly lower value for ‘N’ may be used obtaining comparable results.

Assuming for the sake of simplicity that only basic techniques are implemented to realize the meta-sampling stage, the total sampling error in assessing the audience of channel ‘A’ in this example can be estimated considering that all three sampling processes are linked in series towards the output. In other words, the total audience for a certain channel at any given timeslot is the product of the proportion of individuals viewing television (as determined by the reference panel), multiplied by the share of the channel provided by the mass panel, where the “product” in this case is performed by a digital logic process (i.e. the meta-sampling stage) that introduces further noise in the output data. Since all three processes are totally independent and uncorrelated (regarding the generation of noise), the total error introduced may be estimated by calculating the RMS value over their respective contributions, i.e. ε=SQRT((4.8%)²+(11.5%)²+(4.1%)²)=13.1%.

If only sampling errors respect to channel ‘A’ are taken into account, a comparable result would be obtainable through a traditional respondent panel of 5,761 respondents, for whom all television sets should be equipped with a complete peoplemeter setup, implying high maintenance costs as those associated with such technology. An audience measurement system as the one described above uses instead mobile phones in the mass panel enabling significant operational cost savings, yet being capable of producing high-quality audience data. Such a system does not rely on complex predictive analytics and does not require calibration of regression coefficients.

Analogous examples can be derived from the above explanation using different metering equipment for both the mass and reference panels. The underlying logic is substantially similar in all cases, the differences stemming from eventual performance limitations found in the chosen technologies.

By way of example, diaries filled up by mass respondents may be used instead of mobile phones to save even more on costs. In such case, the performance of the mass panel would be lower than the mobile phone due to known limitations of diaries (e.g. the practical impossibility of producing overnight ratings); yet such an arrangement would provide audience data of higher quality than what would otherwise be achievable by using diaries alone. For example, total audiences indications on a minute-by-minute basis would be achievable in this case (which is not possible using only diaries).

### Variations

While the invention has been illustrated and embodied in a method for measuring audiences, it will be appreciated that a number of modifications and/or system structure changes may be made without departing from the spirit of the present invention.

It will be appreciated that the term “computer system” as used herein refers to any computer-related entity, and encompasses hardware and software, as well as firmware. By way of example, both a server per se and a program that is being run on a server may be regarded as being a computer system. Furthermore, a computer system may run one or more programs which reside a single computer and/or is separable from the device and/or can be run on two or more separate physical media devices.

Whilst many of the embodiments and examples described above relate to measuring television audiences, the present invention is not limited to any particular type of media or broadcasting system. The skilled person will indeed appreciate that the methods and embodiments described can be advantageously applied to a variety of audience measurement applications.

1-58. (canceled)

59. A method of generating a database of media consumption information comprising the steps of:
receiving reference panel consumption information from a plurality of reference panel elements, the reference panel consumption information including reference consumption variables;
receiving mass panel consumption information from a plurality of mass panel elements, the mass panel consumption information including mass consumption variables;
electronically analyzing the reference consumption variables and the mass consumption variables to determine an associated correspondence between at least one of the plurality of reference panel elements and at least one of the plurality of mass panel elements;
establishing a link between at least one of the plurality of reference panel elements and at least one of the plurality of mass panel elements according to the associated correspondence;
electronically assembling a combined panel including combined media consumption information comprised of reference panel consumption information and mass panel consumption information associated with the linked at least one reference panel element and at least one mass panel element; and
electronically storing the combined media consumption information from the combined panel in a memory.

60. The method of claim 59 further comprising determining the associated correspondence by comparing the reference panel consumption variables and mass panel consumption variables against a set of rules of affinity.

61. The method of claim 59 further comprising determining the associated correspondence by analyzing the reference panel consumption variables and the mass panel consumption variables over a period of time.

62. The method of claim 59 further comprising determining the associated correspondence by mapping the reference consumption variables in a session space.

63. The method of claim 59 further comprising determining the associated correspondence by mapping the mass consumption variables in an exposure space.

64. The method of claim 59 further comprising assembling the combined panel by associating each of the plurality of reference panel elements to a plurality of respective proxy elements and associating one of the plurality of mass panel element for each of the respective proxy elements.

65. The method of claim 59 further comprising receiving an enhanced set of reference panel consumption information from television setups metered by peoplemeters.

66. The method of claim 59 further comprising receiving a set of mass panel consumption information from television setups monitored by peoplemeters.

67. The method of claim 59 further comprising receiving a set of mass panel consumption information from television setups monitored by set meters.

68. The method of claim 59 further comprising receiving a set of mass panel consumption information from television set top boxes having RPD capabilities.

69. The method of claim 59 further comprising receiving a set of mass panel consumption information from web server logs.

70. The method of claim 59 further comprising receiving a set of mass panel consumption information from mobile phones having content identification capabilities.

71. The method of claim 59 further comprising mapping at least one reference consumption variable relating to exposure status of the plurality of reference panel elements.

72. The method of claim 59 further comprising mapping at least one reference consumption variable relating to media distribution platforms available for the plurality of reference panel elements.

73. The method of claim 59 further comprising mapping at least one reference consumption variable in a session relating to content choices available for the plurality of reference panel elements.

74. The method of claim 59 further comprising mapping at least one reference consumption variable relating to aggregation of values associated with the consumption variables.

75. The method of claim 59 further comprising assembling the combined panel having structured sets, each set associated to one of the plurality of reference panel elements.

76. The method of claim 59 further comprising assembling the combined panel structured along a first and second dimension.

77. The method of claim 59 further comprising assembling the combined panel having combined media consumption information using a proxy board.

78. An audience measurement system including:
a receiver adapted to receive reference panel consumption information from a plurality of reference panel elements wherein the reference panel consumption information includes reference consumption variables and for receiving mass panel consumption information from a plurality of mass panel elements wherein the mass panel consumption information includes mass consumption variables;
a session affinity determiner having an associated determination logic for analyzing the reference consumption variables and the mass consumption variables to determine an associated correspondence between at least one of the plurality of reference panel elements and at least one of the plurality of mass panel elements;
a sampler having an associated meta-sampling logic for establishing a link between at least one of the plurality of reference panel elements and at least one of the plurality of mass panel elements according to the associated correspondence;
a compiler for generating a combined panel including combined media consumption information comprised of reference panel consumption information and mass panel consumption information associated with the linked at least one reference panel element and at least one mass panel element; and
a memory having a plurality of data structures for storing the combined media consumption information from the combined panel.
